(19) United States
(12) Patent Application Publication
(10) Pub. No.: US 2007/0015589 A1
(43) Pub. Date: Jan. 18, 2007

(54) COMMUNICATION CARD, CONFIDENTIAL INFORMATION PROCESSING SYSTEM, AND CONFIDENTIAL INFORMATION TRANSFER METHOD AND PROGRAM

(75) Inventors: Kazuya Shimizu, Osaka (JP); Tomoya Sato, Osaka (JP); Kentaro Shiomi, Osaka (JP); Yusuke Nemoto, Osaka (JP); Yuishi Torisaki, Osaka (JP); Makoto Fujiwara, Osaka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/456,665

(22) Filed: Jul. 11, 2006

(30) Foreign Application Priority Data
Jul. 12, 2005 (JP) 2005/203570

(51) Int. Cl. A63F 13/00

(52) U.S. Cl. 463/43

(57) ABSTRACT

A communication card comprised of: an interface unit which communicates with the host; a first communication unit which communicates with an external device other than the host; an encryption unit which performs encryption processing onto data transferred between the host device and the external device via the interface unit and the first communication unit; a storage unit which stores: list information indicating a list of identifiers of unauthorized communication cards; and communication key information used for encryption; and a control unit which performs authentication processing, and only when the authentication processing has been completed normally, allows the host to control the first communication unit, causes said encryption unit to encrypt the data by using the communication key information after the authentication processing, and transfers the encrypted data to the host via the interface unit, in which the authentication processing includes processing of revoking an unauthorized communication card by using the list information.

### BACKGROUND OF THE INVENTION

(1) Field of the Invention

The present invention relates to a confidential information processing system that transfers confidential information between a host device and an external device via a communication card connected to the host device, as well as to a communication card and a confidential information transfer method and program.

(2) Description of the Related Art

A system for treating data which requires copyright protection is known that comprises: a memory card having a memory unit represented by an SD (Secure Digital) card for storing data; and a device (referred to as a “host device”, hereinafter) for storing encrypted data into the memory card inserted into a card slot. This system performs authentication processing of confirming whether the memory card and the host device are authorized devices. Then, only when both are recognized as mutually authorized devices, the host device is allowed to process the encrypted data stored in the memory card.

Such a prior art is disclosed for example in Japanese Patent Application No. 2000-357126. FIG. 1 is a diagram showing a prior art confidential information processing system capable of ensuring the confidentiality of data. The confidential information processing system comprises a memory card 2801 and a host device 2800. so Here, examples of this host device include a portable telephone and a PDA (Personal Digital Assistance).

The memory card 2801 comprises: a card controller 2803 which is a circuit for controlling the memory card; a memory unit 2802 for storing data; a public key area 2804 which is an area that stores a key used for performing authentication processing and that can be accessed from the host device without authentication processing; a hidden key area 2805 which is an area that stores a key used for encrypting data and that can be accessed from the host device only when the authentication processing has been completed normally; and a host I/F 2806 for performing an interface function with the host device.

The host device 2800 comprises: a host device controller 2807 which is a circuit for controlling the host device; a data accumulation unit 2808 for storing data; a key area 2809 for storing a key used for performing authentication processing and data encryption; and an encryption circuit 2810 which is a circuit for performing authentication processing and data encryption.

The host device 2800 stores the data stored in the data accumulation unit 2808 of the host device 2800, into the memory unit 2802 of the memory card 2801 in an encrypted form. Specifically, first, in order to determine whether the memory card 2801 and the host device 2800 are authorized devices, authentication processing is performed between these devices. At that time, in the memory card 2801, the key stored in the public key area 2804 is used. In the host device 2800, the key stored in the key area 2809 and the encryption circuit 2810 are used. When both of the memory card 2801 and the host device 2800 are determined as authorized devices in the authentication processing, the host device is allowed to access the hidden key area 2805 of the memory card. In the authentication processing described here, when processing described in Japanese Patent Application No. 2001-166996 or the like is employed, an unauthorized host device can be revoked if an unexpected unauthorized host device is present.

After the authentication processing, the host device 2800 generates a key used for encrypting the data stored in the data accumulation unit 2808, and then encrypts the data by using this key and the encryption circuit 2810. After that, the encrypted data is transferred to the memory unit 2802 of the memory card 2801. Further, the key used in the data encryption is stored into the hidden key area 2805 of the memory card 2801. Thus, the encrypted data in the memory card 2801 can be decrypted only by a host device having been determined as being authorized in the authentication processing. Further, since the data transferred between the memory card 2801 and the host device 2800 is encrypted, its contents do not leak out during the transmission.

Described below is the case that the host device 2800 decrypts the data stored in the memory unit 2802 of the memory card 2801 in an encrypted form, and then stores the decrypted data into the data accumulation unit 2808 of the host device 2800. In this case, similarly to the case that the host device 2800 encrypts and stores data into the memory card 2801, authentication processing is performed first. When both devices are determined as authorized devices in the authentication processing, the host device 2800 is allowed to access the hidden key area 2805 of the memory card 2801. Thus, the key used in the data encryption can be read and is hence transferred to the host device 2800. Then, the encrypted data stored in the memory unit 2802 is transferred to the host device 2800. After that, in the host device 2800, the data is decrypted using the transferred key and the encryption circuit 2810. As described above, the encrypted data in the memory card 2801 can be decrypted only by a host device having been determined as authorized. Further, since the data transferred between the memory card 2801 and the host device 2800 is encrypted, its contents do not leak out during the transmission.

### SUMMARY OF THE INVENTION

In recent years, a memory-card type device (referred to as a “communication card”, hereinafter) is used that has the function of receiving data from a terminal (referred to as a “data distribution terminal”, hereinafter) for performing data distribution. Such a communication card is used in a state of being inserted into a memory card slot of the host device described above. Here, as for a data transfer method from the data distribution terminal, various wireless communication techniques represented by the wireless LAN are used. A communication card having the function of receiving data by such wireless communication is referred to as a wireless communication card in particular. In such a wireless communication card, from the perspective of copyright protection and personal information protection, necessity arises that the data to be transferred should be treated in an encrypted form. In general, confidentiality between the data distribution terminal and the wireless communication card is achieved by means of authentication processing and data encryption represented by the DTCP (Digital Transmission Content Protection) technique. In this case, the data is encrypted and transferred by a data distribution terminal, and then decrypted by a wireless communication card recognized as being authorized in the authentication processing, so that data confidentiality is achieved. Nevertheless, even when the DTCP is employed, confidentiality is not ensured in data transfer between the wireless communication card and the host device.

As described above, in the confidential information processing system shown in FIG. 1, confidentiality is achieved in the data transfer between the memory card 2801 and the host device 2800. Thus, an approach would be promising that the confidentiality ensuring method of the confidential information processing system shown in FIG. 1 is applied to the wireless communication card so that data confidentiality should be achieved.

In this case, in an example of circuit configuration, the memory unit 2802 of the memory card 2801 shown in FIG. 1 is replaced by a circuit for performing data transfer with the outside.

However, as for the data reception from the data distribution terminal, the confidentiality ensuring method described above could allow an unauthorized host device to access without authentication processing the circuit for performing wireless communication of the wireless communication card. Thus, a problem is that the host device could receive the data without authorization. Further, the above-mentioned confidentiality ensuring method does not employ a data encryption method in the wireless communication card. Thus, even when a host device recognized as being authorized in the authentication processing uses the wireless communication card, the received data is transferred to the host device without encryption. Thus, a problem is that the data may leak out in the course of transmission between the wireless communication card and the host device. Furthermore, the method does not employ a method of revoking an unexpected unauthorized wireless communication card like a communication card having a modified circuit configuration permitting data reception without authorization.

An object of the present invention is to provide a communication card, a confidential information processing system, and a confidential information transfer method and program capable of preventing an unauthorized host device from sending and receiving data by using the communication card without authorization and of revoking an unexpected unauthorized communication card.

In order to achieve the above-mentioned object, the communication card of the present invention is a communication card connected to a host device, including: an interface unit which communicates with the host device; a first communication unit which communicates with an external device other than the host device; an encryption unit which performs encryption processing onto data transferred between the host device and the external device via the interface unit and the first communication unit; a a storage unit which stores the following: list information indicating a list of identifiers of unauthorized communication cards; and communication key information used for performing encryption processing onto the data; and a control unit which performs authentication processing between the communication card and the host device, and only when the authentication processing has been completed normally, allows the host device to control the first communication unit, causes the encryption unit to encrypt the data by using the communication key information after the authentication processing, and transfers the encrypted data to the host device via the interface unit, wherein the authentication processing includes processing of revoking, by using the list information, an unexpected unauthorized communication card.

According to this configuration, the only host device allowed to use the first communication unit in the communication card is the host device authenticated as being authorized. This prevents an unauthorized host device from sending and receiving data by using the communication card without authorization. Further, an unexpected unauthorized wireless communication card can be revoked. Furthermore, when a host device is recognized as being authorized in the authentication processing, data transferred between the communication card and the host device is encrypted by the encryption unit. Thus, the data transfer between the communication card and the host device is achieved with confidentiality.

Here, the configuration may be such that the communication card further includes a memory unit which stores data, wherein the control unit: causes the encryption unit to encrypt, by using the communication key information, the data received from the external device by the first communication unit, stores the encrypted data into the memory unit, and transfers the encrypted data stored in the memory unit to the host device through the interface unit; stores in the memory unit the encrypted data received from the host device by the interface unit, and causes the encryption unit to decrypt by using the communication key information the encrypted data stored in the memory unit; and transfers the decrypted data to the external device via the first communication unit

According to this configuration, the data stored in the memory unit is retained in an always readable state unless deleted. However, the data is encrypted with the communication key information. This prevents read-out from an unauthorized host device not having undergone the authentication processing normally.

Here, the configuration may be such that the control unit performs first, second, and third processing in the authentication processing, the first processing is processing of determining whether both of the communication card and the host device are authorized ones, the second processing is processing of revoking an unexpected unauthorized host device, and the third processing is processing of revoking, by using the list information, an unexpected unauthorized communication card.

According to this configuration, in the first processing, the communication card and the host device are authenticated as being authorized mutually. Then, in the second processing, a host device spoofing as if being authorized is revoked. Further, in the third processing, a communication card spoofing as if being authorized is revoked.

Here, the configuration may be such that the first communication unit has an encryption circuit which performs encryption processing onto the data, and communicates, with the external device, encrypted data encrypted by the encryption circuit, the communication card further includes a second communication unit which communicates non-encrypted data with the external device, and the control unit allows the host device to use the second communication unit without authentication processing, and transfers non-encrypted data between the second communication unit and the interface unit.

According to this configuration, as for data not requiring confidentiality, the host device communicates with a device other than the host via the second communication unit, while as for data requiring confidentiality, the host device communicates with a device other than the host via the first communication unit. The two methods can be selected in accordance with the necessity or non-necessity of confidentiality of the data.

Here, the configuration may be such that the communication card further includes one or more second communication units, each of which has a second encryption circuit which performs encryption processing onto communication data, and communicates to an external device encrypted data generated by the second encryption circuit, and the control unit further performs authentication processing between the communication card and host devices, using individually different information, and, only when the authentication processing has been completed normally, allows a host device to control the second communication unit corresponding to each authentication processing, then after the authentication processing, causes the encryption unit to encrypt the data by using communication key information different from the communication key information, and transfers the encrypted data to the host device via the interface unit.

According to this configuration, the host device need perform authentication processing which is different between the first communication unit and the second communication unit. This ensures the confidentiality of data even when a plurality of communication units are present.

Here, the configuration may be such that the first communication unit has a first encryption circuit which performs encryption processing onto communication data, and communicates, with the external device, encrypted data encrypted by the first encryption circuit, the communication card further includes one or more second communication units, each of which has a second encryption circuit which performs encryption processing onto communication data, and communicates to an external device encrypted data generated by the second encryption circuit, and when the authentication processing has been completed normally, the control unit further allows the host device to control each of the second communication units, causes the encryption unit to encrypt, by using the communication key information, the data obtained from the second communication unit, and transfers the encrypted data to the host device via the interface unit.

According to this configuration, when the host device uses the first communication unit or the second communication unit, the authentication processing is shared. Further, in the encryption processing, the communication key information is shared so that a single kind of encryption processing can be used solely. This permits reduction in the time of authentication processing, the size of area for storing the key, and the circuit size of the encryption unit.

Here, the configuration may be such that the communication card further includes a holding unit which holds authentication information indicating whether authentication processing is necessary between a host device and a communication card, wherein the control unit allows the host device to control the first communication unit without authentication processing when the authentication information indicates that authentication processing is unnecessary.

According to this configuration, as for data not requiring confidentiality or alternatively a reliable host device, authentication processing between the host device and the wireless communication card can be omitted. Further, when reading the authentication information, the host device can easily recognize the necessity or non-necessity of authentication.

Here, the configuration may be such that the communication card further includes a holding unit which holds encryption information indicating whether encryption processing is necessary between a host device and a communication card, wherein the control unit performs data transfer between the host device and the first communication unit without encryption processing when the encryption information indicates that encryption processing is unnecessary.

According to this configuration, when reading the encryption information, the host device can easily recognize the necessity or non-necessity of encryption processing. This reduces the time of checking whether the data is encrypted.

Here, the configuration may be such that the communication card further includes a holding unit which holds memory information indicating whether data is stored in the memory unit and that can be read from the host device.

According to this configuration, when reading the memory information, the host device can easily recognize whether data is stored in the memory unit. Thus, data transfer between the host device and a device other than the host can be switched easily between a mode of performing via the memory unit and a mode of performing without the memory unit.

Here, the configuration may be such that the communication card further includes a holding unit which holds completion information indicating whether authentication processing has been completed normally and that can be read from the host device.

According to this configuration, when reading the completion information, the host device can easily check whether the authentication processing has been completed normally.

Here, the configuration may be such that the storage unit has a public area which is an area accessible even from an unauthenticated host device and a hidden area which is an area accessible only from an authorized and authenticated host device, the public area has a first area that can only be read by a host device, the first area holds an authentication card key which is a key proper to each communication card and used in the third processing, the hidden area has a second area which is an area that cannot be read and written by a host device, the second area holds a first authentication key which is an expected value of a first authentication key generated in the first or the second processing, and the authentication card key is encrypted with the first authentication key.

According to this configuration, the authentication card key is encrypted in advance with the first authentication key and then held in the first area. Thus, before the third processing, only when the first authentication key is correctly generated in the first or the second processing, the third processing can be performed using the authentication card key.

Here, the configuration may be such that the second area further holds a communication key which is a key used for encryption and decryption of data by the communication card, the communication key being included in the communication key information.

According to this configuration, the communication key used by the communication card is stored in the second area within the hidden area. This prevents the host device from recognizing the value of the communication key without authorization and from replacing the communication key without authorization.

Here, the configuration may be such that the control unit, in the first processing, authenticates an authorization status of a host device by using the following: an authentication host key indicating an identifier of the host device; and a first authentication slave key indicating a list of identifiers of authorized host devices, in the second processing, revokes an unauthorized host device by using the authentication host key, and a second authentication slave key indicating a list of identifiers of unexpected unauthorized host devices, and in the third processing, provides to the host device the authentication card key and a third authentication slave key which is the list information, and to cause the host device to revoke an unauthorized communication card, and that the second processing is omitted in a case that the second authentication slave key is not present, and the third processing is omitted in a case that the third authentication slave key is not present.

Here, the configuration may be such that the hidden area further has a third area which is an area that can be read and written by the host device only when the authentication processing has been completed normally, the third area holds the communication key, and the communication key is encrypted in advance with the first authentication key in a case that only the first processing is performed in the authentication processing, encrypted in advance with a second authentication key which is a key generated in the second processing, in a case that only the first processing and the second processing are performed in the authentication processing, and encrypted in advance with a third authentication key which is a key generated in the third processing, in a case that the first processing through the third processing are performed in the authentication processing or alternatively in a case that only the first processing and the third processing are performed.

According to this configuration, the communication key is encrypted in advance with any one of the first authentication key, the second authentication key, and the third authentication key, and then stored into the third area. This prevents a host device not having undergone correct authentication processing from decrypting the communication key without authorization and performing encryption processing or decryption processing for the data.

Here, the configuration may be such that the public area further has a fourth area which is an area that can be read and written by a host device, the fourth area is an area which holds the third authentication slave key, and the third authentication slave key is: encrypted in advance with a first authentication intermediate key which is a key generated in the first processing, in a case that only the first processing and the third processing are performed in the authentication processing; and encrypted in advance with a second authentication intermediate key which is a key generated in the second processing, in a case that the first processing through the third processing are performed in the authentication processing.

According to this configuration, the third authentication slave key is encrypted in advance with any one of the first authentication intermediate key and the second authentication intermediate key, and then stored into the fourth area. This prevents a host device not having undergone correct authentication processing from decrypting the third authentication slave key and performing the third authentication processing.

Further, the confidential information processing system of the present invention is a confidential information processing system including a host device and a communication card connectable to the host device, the communication card including: an interface unit which communicates with the host device, a first communication unit which communicates with an external device other than the host device, an encryption unit which performs encryption processing onto data transferred between the host device and the external device via the interface unit and the first communication unit, a storage unit which stores the following: list information indicating a list of identifiers of unauthorized communication cards; and communication key information used for performing encryption processing onto the data, and a first control unit which controls the communication card, the host device including: a card slot which connects with the communication card, and a second control unit which controls the host device, wherein the host device and the communication card perform authentication processing between the communication card and the host device, and only when the authentication processing has been completed normally, the first control unit: allows the host device to control the first communication unit; causes the encryption unit to encrypt the data by using the communication key information after the authentication processing, and transfers the encrypted data to the host device via the interface unit, and wherein the authentication processing includes processing of revoking, by using the list information, an unexpected unauthorized communication card.

According to this configuration, the only host device allowed to use the first communication unit in the communication card is the host device authenticated as being authorized. This prevents an unauthorized host device from sending and receiving data by using the communication card without authorization. Further, an unexpected wireless communication card can be revoked. Furthermore, when a host device is recognized as being authorized in the authentication processing, data transferred between the communication card and the host device is encrypted by the encryption unit. Thus, the data transfer between the communication card and the host device is achieved with confidentiality.

Further, the confidential information transfer method and program of the present invention comprises the same units as described above.

When the confidential information processing system of the present invention is used, authentication processing of confirming whether the wireless communication card and the host device are authorized devices is performed. Then, only the host device recognized as being authorized on the basis of the processing result is allowed to use the circuit for performing wireless communication in the wireless communication card. This prevents an unauthorized host device is allowed to send and receive data without authorization. Further, since a key is used for identifying an unexpected wireless communication card in the authentication processing, the unexpected unauthorized wireless communication card can be revoked. Further, when a host device is recognized as being authorized in the authentication processing, data transferred between the wireless communication card and the host device is encrypted so that confidentiality is achieved in the data transfer.

### FURTHER INFORMATION ABOUT TECHNICAL BACKGROUND TO THIS APPLICATION

The disclosure of Japanese Patent Application No. 2005-203570 filed on Jul. 12, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a configuration of a confidential information processing system employing a memory card.

FIG. 2 is a diagram showing a configuration of a confidential information processing system according to Embodiment 1 of the present invention.

FIG. 3 is a diagram showing a processing method performed by a wireless communication card at the time of encrypted data reception.

FIG. 4 is a diagram showing a processing method performed by a wireless communication card at the time of encrypted data sending.

FIG. 5A is a diagram showing a configuration of a public key area.

FIG. 5B is a diagram showing a configuration of a hidden key area.

FIG. 6 is a diagram showing outlines of an authentication processing method performed between a wireless communication card and a host device.

FIG. 7 is a diagram showing a method of encryption processing and decryption processing for received data performed using a communication key.

FIG. 8 is a diagram showing an authentication processing method performed between a wireless communication card and a host device.

FIG. 9 is a diagram showing a third identification processing method in an authentication processing method performed between a wireless communication card and a host device.

FIG. 10 is a diagram showing a data decryption processing method performed in a host device.

FIG. 11 is a diagram showing a data encryption processing method performed in a host device.

FIG. 12 is a diagram showing a method of updating a third authentication slave key in a wireless communication card performed by a host device.

FIG. 13 is a diagram showing a method of re-encrypting an encrypted communication key performed in a host device.

FIG. 14 is a diagram showing a method of replacement processing for an encrypted communication key in the wireless communication card.

FIG. 15 is a diagram showing a method of changing values of a communication key and an encrypted communication key in a wireless communication card.

FIG. 16 is a diagram showing a method of encryption key confirmation for an encrypted communication key in a wireless communication card.

FIG. 17 is a diagram showing a data reception method for a case that data encryption is performed selectively.

FIG. 18 is a diagram showing a data sending method for a case that data encryption is performed selectively.

FIG. 19 is a diagram showing a configuration of a memory-equipped wireless communication card according to Embodiment 2 of the present invention.

FIG. 20 is a diagram showing a processing method performed by a memory-equipped wireless communication card at the time of encrypted data reception.

FIG. 21 is a diagram showing a processing method performed by a memory-equipped wireless communication card at the time of encrypted data sending.

FIG. 22 is a diagram showing a circuit configuration of a wireless communication card according to Embodiment 3 of the present invention.

FIG. 23 is a diagram showing data flow for a case that a wireless communication controller is used.

FIG. 24 is a diagram showing a circuit configuration of a memory-equipped wireless communication card according to Embodiment 4 of the present invention.

FIG. 25 is a diagram showing data flow for a case that a wireless communication controller is used in a memory-equipped wireless communication card.

FIG. 26 is a diagram showing data flow for a case that a non-encrypted wireless communication controller is used.

FIG. 27 is a diagram showing a configuration of a wireless communication register unit of a wireless communication card.

FIG. 28A is a diagram showing an example of configuration of a communication circuit information register.

FIG. 28B is a diagram showing an example of configuration of an authentication information register.

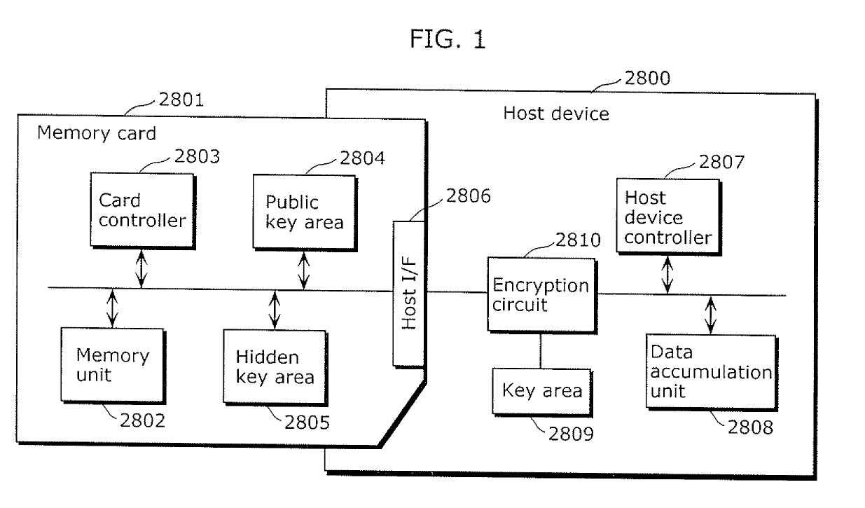

### DESCRIPTION OF THE PREFERRED EMBODIMENTS

Embodiments of the present invention are described below with reference to the drawings.

### Embodiment 1

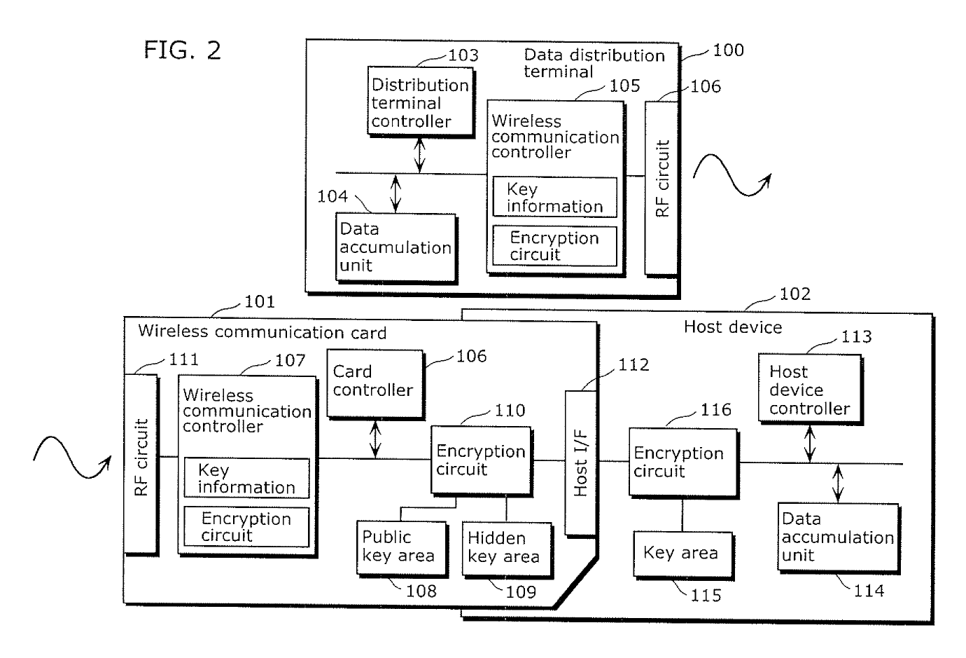

FIG. 2 is a diagram showing a configuration of a confidential information processing system according to Embodiment 1.

In FIG. 2, the confidential information processing system comprises a data distribution terminal 100, a wireless communication card 101, and a host device 102. The data distribution terminal 100 comprises: a distribution terminal controller 103 which is a circuit for controlling the terminal; the data accumulation unit 104; a wireless communication controller 105 which is a circuit for transferring encrypted data to the wireless communication card 101 by wireless communication; and an RF circuit 106 serving as a radio antenna. Further, the wireless communication controller 105 includes key information and an encryption circuit for the purpose of authentication processing with the wireless communication card 101 and encryption of data.

The wireless communication card 101 comprises: a card controller 106 which is a circuit for controlling the card; a wireless communication controller 107 which is a circuit for transferring encrypted data to the data distribution terminal 100 by wireless communication; a public key area 108 which is an area that stores a key used for performing authentication processing with the host device 102 and that can be accessed from the host device without authentication processing; a hidden key area 109 which is an area that stores an encryption key used for performing data encryption with the host device 102 and that can be accessed from the host device only when the authentication processing has been completed normally; an encryption circuit 110 which is a circuit for performing data encryption with the host device 102; an RF circuit 111 serving as a radio antenna; and a host I/F 112 for performing interface control with the host device 102. Here, similarly to the case of the data distribution terminal 100, the wireless communication controller 107 is provided with key information and an encryption circuit. Further, mutual authentication is performed between the wireless communication card 101 and the host device 102, and then only when both devices are recognized as being mutually authorized, the wireless communication controller 107 can be controlled from the host device 102.

The host device 102 comprises: a host device controller 113 which is a circuit for controlling the host device; a data accumulation unit 114; a key area 115 for storing a key used for performing authentication processing and data encryption with the wireless communication card 101; and an encryption circuit 116 which is a circuit for performing authentication processing and data encryption with the wireless communication card 101.

In the present Embodiment 1, wireless communication is assumed between the data distribution terminal 100 and the wireless communication card 101. However, the circuit for wireless communication may be replaced so that the data transfer may be performed by another communication method such as cable communication. In the following description, the confidential information processing system of the present invention is explained for the case of wireless communication.

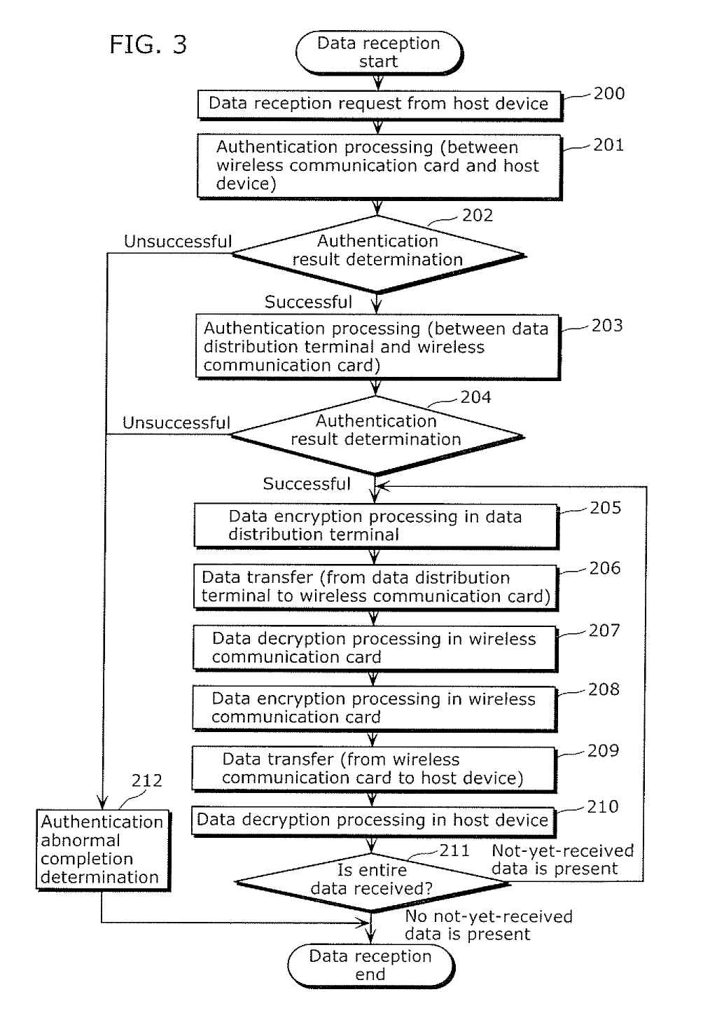

FIG. 3 is a diagram showing a processing method performed when the host device 102 receives encrypted data from the data distribution terminal 100 in the confidential information processing system shown in FIG. 2. This processing is described below for the case that data reception is started in response to a data reception request 200 from the host device. In the following description, the operation of data reception in the confidential information processing system of FIG. 2 is explained with reference to FIG. 3.

In this processing method, when a data reception request 200 from the host device is sent to the data distribution terminal 100 via the wireless communication card 101, authentication processing 201 is performed between the wireless communication card 101 and the host device 102. Used at the time are: the key stored in the public key area 108 of the wireless communication card 101; the key stored in the key area 115 of the host device 102; and the encryption circuit 116. Details of the key used and the authentication processing are described later. In authentication result determination 202, when the authentication is unsuccessful, authentication abnormal completion determination 212 is executed so that subsequent processing is not executed. In contrast, when the authentication is successful so that both of the wireless communication card 101 and the host device 102 has been determined as being authorized devices, the host device 102 is allowed to access the hidden key area 109 of the wireless communication card and control the wireless communication controller 107.

Then, authentication processing 203 is performed between the data distribution terminal 100 and the wireless communication card 101. Here, the key information and the encryption circuit present in each wireless communication controller are used. Then, when both devices are recognized as being authorized devices, data transmission is performed. Here, the authentication processing between the data distribution terminal 100 and the wireless communication card 101 may be performed in an arbitrary form. That is, another method other than that described in the present embodiment may be adopted as long as both devices are ensured to be authorized devices.

Further, in the present embodiment it is assumed that data is received in response to the data reception request 200 from the host device. However, the host device may start data reception in response to a data sending request from the data distribution terminal 100. In this case, the authentication processing 203 between the data distribution terminal 100 and the wireless communication card 101 is executed before the authentication processing 201 performed between the wireless communication card and the host device.

After the completion of authentication processing, in the data distribution terminal 100, data encryption processing 205 is performed on the data present in data accumulation unit 104. This processing is performed by the wireless communication controller 105. In the processing, the key information and the encryption circuit in the wireless communication controller are used. The encrypted data is transferred to the wireless communication card 101 via the RF circuit 106 of the data distribution terminal 100. In the wireless communication card 101, this data is received through the RF circuit 111. Then, in the wireless communication controller 107, decryption processing 207 is performed using the key information and the encryption circuit. As a result, decrypted data is temporarily generated in the wireless communication card. Here, similarly to the authentication processing, the data encryption performed between the data distribution terminal 100 and the wireless communication card 101 may be performed by another method. That is, another method other than that described in the present embodiment may be adopted as long as data confidentiality is ensured.

Then, in the wireless communication card 101, in order to transfer the data to the host device 102, the encryption circuit 110 performs data encryption processing 208. Here, the key stored in the hidden key area 109 is used. Details of the key used and the encryption processing are described later The data encrypted with this key is transferred to the host device 102 via the host I/F 112. The host device 102 having received the data performs decryption processing 210 for the data by using the key stored in the key area 115 as well as the encryption circuit 116. Details of the key used here and the encryption processing are also described later. As a result, the decrypted data is held in the host device 102. Then, the data is stored into the data accumulation unit 114, and then processing on this data is completed. When data to be received from the data distribution terminal 100 still remains, data transfer from the data distribution terminal is repeated.

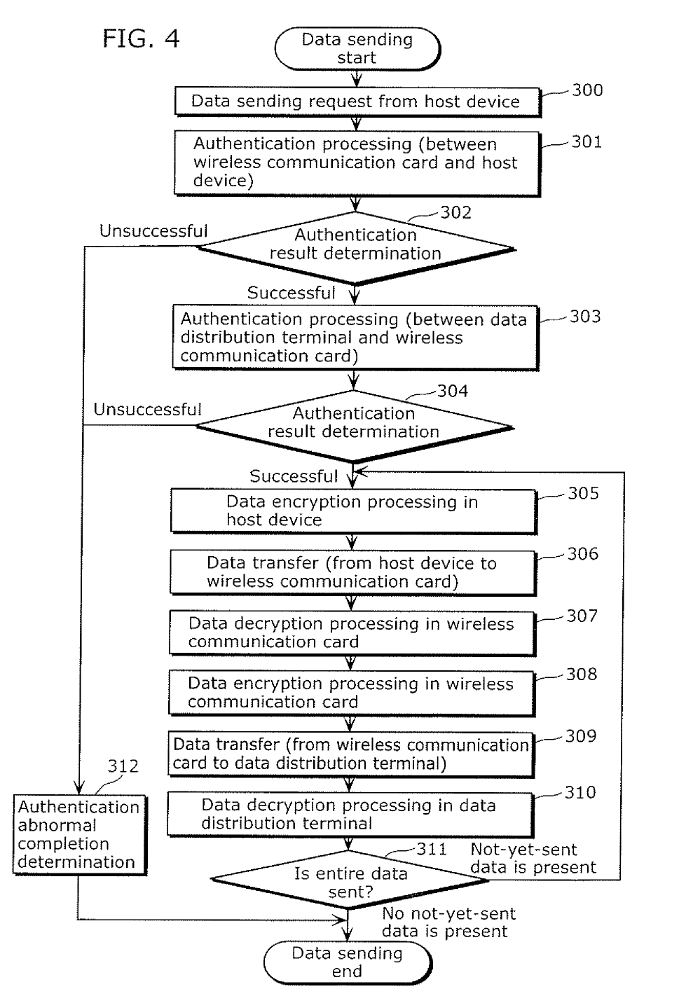

FIG. 4 is a diagram showing a processing method performed when the host device 102 sends encrypted data to the data distribution terminal 100 in the confidential information processing system shown in FIG. 2. As shown in this figure, in the confidential information processing system of the present invention, the host device 102 can also send data to the data distribution terminal 100. The following description is given for the case that data sending is started in response to a data sending request 300 from the host device. In the following description, the operation of data sending in the confidential information processing system of FIG. 2 is explained with reference to FIG. 4.

In this processing method, by using a method similar to that used in data reception, authentication processing 301 is performed between the wireless communication card 101 and the host device 102. When the authentication is successful, the host device 102 is allowed to access the hidden key area 109 of the wireless communication card and control the wireless communication controller 107. Then, authentication processing 303 is performed between the data distribution terminal 100 and the wireless communication card 101. In authentication result determination 304, when both devices are recognized as being authorized devices, data transmission is performed. Here, similarly to the case of data reception, the host device may start data sending in response to a data reception request from the data distribution terminal 100. In this case, the authentication processing 303 between the data distribution terminal 100 and the wireless communication card 101 is executed before the authentication processing 301 performed between the wireless communication card and the host device.

After the completion of authentication processing, in the host device 102, data encryption processing 305 is performed on the data present in data accumulation unit 114. Here, the key present in the key area 115 of the host device 102 and the encryption circuit 116 are used. Then, the encrypted data is transferred to the wireless communication card 101 through the host I/F 112. Then, data decryption processing 307 is performed on the transferred data in the wireless communication card 101. Here, the key stored in the hidden key area 109 and the encryption circuit 110 are used. The key and the encryption method used here are described later. After that, in the wireless communication card 101, for the purpose of transfer to the data distribution terminal 100, the wireless communication controller 107 performs encryption processing 308. The wireless communication card 101 transfers this data to the data distribution terminal 100 through the RF circuit 111. The transferred data is received by the RF circuit 106 in the data distribution terminal 100. Then, decryption processing 310 is performed by the wireless communication controller 105. Then, the data distribution terminal 100 stores the data decrypted by data accumulation unit 104. Then, processing on this data is completed. When data to be sent from the host device 102 still remains, data transfer from the host device is repeated.

Further, the authentication processing 201 in FIG. 3 and the authentication processing 301 in FIG. 4 include the processing of determining whether the wireless communication card 101 is an unexpected unauthorized card. Information necessary for this determination processing is provided as a key stored in the public key area 108 of the wireless communication card 101. In this processing, when the wireless communication card 101 is determined as an unexpected unauthorized card, authentication abnormal completion determination is concluded in authentication result determination, so that subsequent processing is not performed. Details of the key and the processing used here are described later.

As described above, processing shown in FIGS. 3 and 4 are performed in the confidential information processing system shown in FIG. 2. Then, only when both of the wireless communication card and the host device are recognized as authorized devices in the authentication processing, data transfer with the data distribution terminal is allowed. This prevents an unauthorized host device from using the wireless communication controller. Further, in the authentication processing, an unexpected wireless communication card can be revoked. Then, in the data transfer after the authentication processing, the data transferred between the wireless communication card and the host device is encrypted so that confidentiality is achieved in the transferred data.

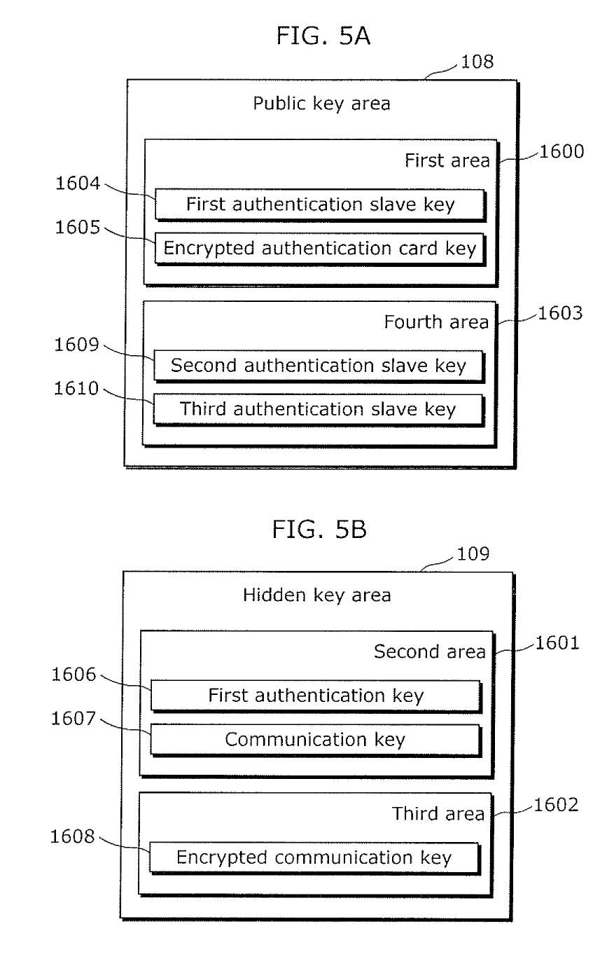

FIGS. 5A and 5B are diagrams showing a configuration of public key area 108 and the hidden key area 109.

The public key area 108 and the hidden key area 109 are present in the wireless communication card. The public key area 108 comprises: a first area 1600 which is an area that is read-only from the host device; and a fourth area 1603 shown in an area that can be read and written from the host device. The public key area 108 stores a key necessary for authentication processing. The hidden key area 109 comprises: a second area 1601 which is an area that cannot be read and written from the host device; and a third area 1602 which is an area that can be read and written only when the host device has been recognized as being authorized in the authentication processing. The hidden key area 109 stores a key necessary for data encryption. The key stored in the second area is used also in the authentication processing.

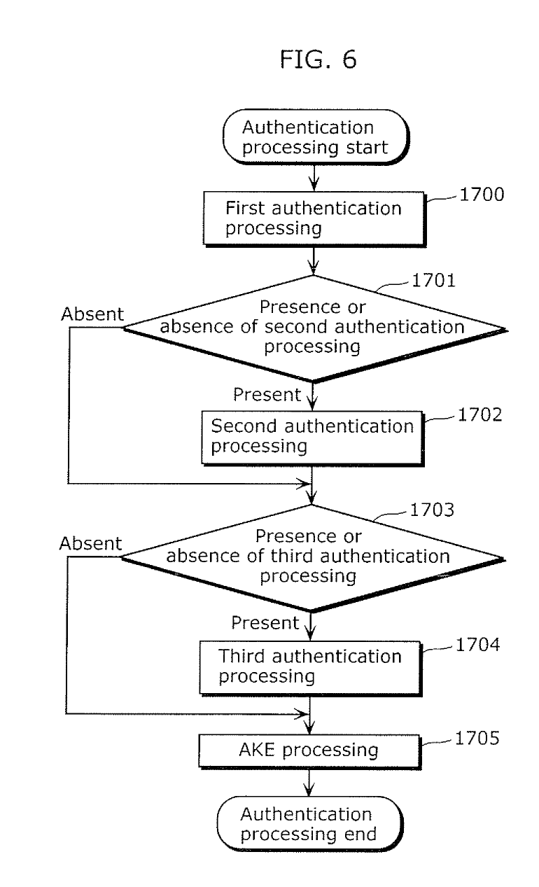

Here, in the description of the key stored in each area, authentication processing is explained that is performed between the wireless communication card and the host device in the confidential information processing system of the present invention. FIG. 6 shows outlines of the authentication processing, and corresponds to the authentication processing 201 performed between the wireless communication card and the host device of FIG. 3 and the authentication processing 301 performed between the wireless communication card and the host device of FIG. 4. As shown in FIG. 6, the authentication processing includes a first authentication processing 1700, a second authentication processing 1702, a third authentication processing 1704, and an AKE (Authentication and Key Exchange) processing 1705. Here, the processing other than the third authentication processing 1704 may be that employed in the authentication processing disclosed in Japanese Patent Application No. 2000-357126 and Japanese Patent Application No. 2001-166996 described above.

The first authentication processing 1700 is processing of confirming whether an identifier proper to the host device is present in a list that indicates the identifiers of host devices allowed to use the system and that is present in the wireless communication card. That is, the processing determines whether the identifier of interest is authorized. In the authentication processing of the present invention, the above-mentioned identifier is referred to as an authentication host key, while the above-mentioned list is referred to as a first authentication slave key. Further, in the first authentication processing 1700, two keys are generated in the host device. The first key is an intermediate key generated during the authentication processing and is referred to as a first authentication intermediate key. The second key is a key generated on the basis of the authentication processing result and is referred to as a first authentication key.

The second authentication processing 1702 is processing of revoking an unexpected unauthorized host device, and is executed when an unexpected unauthorized host device is reported. When no host device is reported, this processing is not executed. This processing is processing of confirming whether the authentication host key is present in a list that is stored in the wireless communication card and that indicates authentication host keys of unexpected unauthorized host devices. That is, the processing determines whether the authentication host key of interest is a key to be revoked. In the authentication processing of the present invention, this list is referred to as a second authentication slave key. Further, in the second authentication processing 1702, two keys are generated in the host device. The first key is an intermediate key generated during the authentication processing and is referred to as a second authentication intermediate key. The second key is a key generated on the basis of the authentication processing result and is referred to as a second authentication key.

The third authentication processing 1704 is processing of revoking an unexpected unauthorized wireless communication card, and is executed when an unexpected unauthorized wireless communication card is reported. When no wireless communication card is reported, this processing is not executed. This processing is processing of confirming whether an identifier proper to the wireless communication card is present in a list that is stored in the wireless communication card and that indicates the identifiers of unexpected unauthorized wireless communication cards. That is, the processing determines whether the identifier of interest is a key to be revoked. In the authentication processing of the present invention, the above-mentioned identifier is referred to as an authentication card key, while the above-mentioned list is referred to as a third authentication slave key. Further, in the third authentication processing 1704, two keys are generated in the host device. The first key is an intermediate key generated during the authentication processing and is referred to as a third authentication intermediate key. The second key is a key generated on the basis of the authentication processing result and is referred to as a third authentication key.

The AKE processing 1705 is processing of confirming whether the above-mentioned first authentication key has correctly been generated in the first authentication processing 1700. In this processing, determination is performed by confirming whether the first authentication key stored as an expected value in the wireless communication card in advance is identical to the first authentication key generated by the host device. In this processing, when the first authentication key has been determined as being correctly generated in the host device, it is determined that the authentication processing has been completed normally.

In the confidential information processing system of the present invention, in the execution of the above-mentioned authentication processing, keys used for performing the third authentication processing need be prepared newly and then stored. Thus, in the confidential information processing system of the present invention, as shown in FIGS. 5A and 5B, the keys concerning the third authentication processing are stored into the public key area 108 and the hidden key area 109 of the wireless communication card. In the following description, these keys necessary for the third authentication processing and the method of storing the keys are explained.

First, an encrypted authentication card key 1605 generated by encrypting the authentication card key is stored into the first area 1600. In the authentication processing, the host device reads this key and then uses the key within the host device. Here, the encrypted authentication card key 1605 is encrypted in advance with the first authentication key. Thus, in order that the host device uses the authentication card key in the authentication processing, the first authentication key need be generated correctly in the first authentication processing 1700.

As such, since the authentication card key is encrypted in advance with the first authentication key and then stored in the first area 1600, in the third authentication processing 1704 to be performed by the host device, the authentication card key can be used only when the first authentication key has been generated correctly.

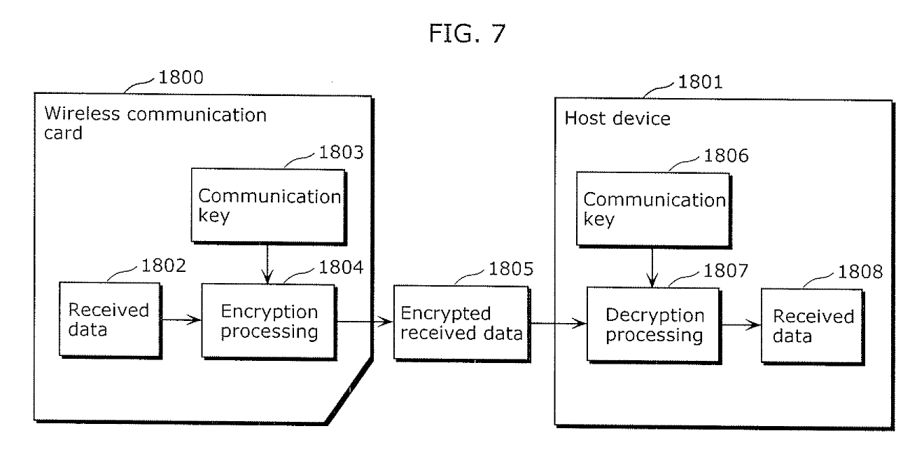

In the confidential information processing system of the present invention, data encryption is performed in the data transfer between the wireless communication card and the host device. At the time, a key is necessary for encryption. This key is stored in the hidden key area 109 of the wireless communication card. In the description of this key, encryption processing and decryption processing for the transmission data of the confidential information processing system of the present invention are explained below. FIG. 7 is a diagram showing the flow of encryption processing and decryption processing for received data. The present processing corresponds to the part from the data encryption processing 208 in the wireless communication card to the data decryption processing 210 in the host device shown in FIG. 3.

When transferred to the host device, received data 1802 received by the wireless communication card 1800 is encrypted in encryption processing 1804 with a communication key 1803 which is a key used for achieving encryption in the data transfer between the wireless communication card 1800 and the host device 1801. Then, the received data 1802 is transferred as encrypted received data 1805 to the host device 1801. The sent data is decrypted in decryption processing 1807 with a communication key 1806 held in the host device. Thus, the communication keys held by the wireless communication card 1800 and the host device 1801 have the same value. Further, in the case of data sending, decryption processing is performed in the wireless communication card 1800, while encryption processing is performed in the host device 1801.

In the above-mentioned processing, the communication key 1803 used in the wireless communication card is stored in the second area 1601 of the hidden key area 109 as shown in FIG. 5B. In the encryption processing or the decryption processing for the data, the wireless communication card reads and uses this communication key. Here, as described above, the second area 1601 cannot be read and written from the host device. Thus, the host device cannot recognize the value of the communication key that has been encrypted or decrypted in the wireless communication card. Further, the host device cannot replace the communication key used in the wireless communication card.

As such, the communication key used by the wireless communication card is stored in the second area 1601. This prevents the host device from recognizing the value of the communication key and from replacing the communication key.

As shown in FIG. 7, the host device 1801 uses the communication key 1806 in the encryption processing and the decryption processing for the data. At the time, this communication key is stored in the third area 1602 of the hidden key area 109 of the wireless communication card. Further, at the time, the storing is performed in the form of an encrypted communication key 1608 which is encrypted in advance. Further, as described above, the not-yet-encrypted communication key has the same value as the communication key 1607 stored in the second area 1601.

Here, in the authentication processing shown in FIG. 6, in the case that only the first authentication processing 1700 is performed, the encrypted communication key 1608 is stored in a form encrypted in advance with the first authentication key. In contrast, in the case that the second authentication processing 1702 is performed in addition to the first authentication processing 1700, the encrypted communication key 1608 is stored in a form encrypted in advance with the second authentication key. Further, in the case that the first authentication processing 1700, the second authentication processing 1702, and the third authentication processing 1704 are performed, or alternatively in the case that the third authentication processing 1704 is performed in addition to the first authentication processing 1700, the encrypted communication key 1608 is stored in a form encrypted in advance with the third authentication key. Thus, in order that a decrypted communication key should be held in the host device, necessary processing among the first authentication processing 1700, the second authentication processing 1702, and the third authentication processing 1704 need be performed correctly so that the authentication key used for the encryption of the encrypted communication key 1608 need be generated in the host device.

As such, the communication key is encrypted in advance with any one of the first authentication key, the second authentication key, and the third authentication key, and then stored into the third area 1602. This prevents a host device not having undergone correct authentication processing from decrypting the communication key without authorization and performing encryption processing or decryption processing for the data.

As described above, in the third authentication processing 1704 shown in FIG. 6, the third authentication slave key is used as input. Thus, the third authentication slave key is stored in a form encrypted in advance into the fourth area 1603 of the public key area 108. Here, in the authentication processing shown in FIG. 6, in the case that the third authentication processing 1704 is performed in addition to the first authentication processing 1700, the third authentication slave key 1610 is stored in a form encrypted in advance with the first authentication intermediate key. In contrast, in the case that the first authentication processing 1700, the second authentication processing 1702, and the third authentication processing 1704 are performed, the third authentication slave key 1610 is stored in a form encrypted in advance with the second authentication intermediate key. Thus, in order that the third decrypted authentication slave key should be used in the host device, the first authentication processing need be executed correctly in the case that the third authentication processing 1704 is performed in addition to the first authentication processing 1700. In contrast, in the case that the first authentication processing 1700, the second authentication processing 1702, and the third authentication processing 1704 are performed, the second authentication processing need be executed correctly.

As such, the third authentication slave key is encrypted in advance with any one of the first authentication intermediate key and the second authentication intermediate key, and then stored into the fourth area 1603. This prevents a host device not having undergone correct authentication processing from decrypting the third authentication slave key and performing the third authentication processing.

In the wireless communication card of the confidential information processing system of the present invention, a plurality of wireless communication controllers may be employed. Further, individual authentication processing may be required for each of the wireless communication controllers, In this configuration, keys each corresponding to the authentication processing and the encryption processing for each wireless communication controller need be stored.

Thus, the part from the first area 1600 to the fourth area 1603 of the public key area 108 and the hidden key area 109 shown in FIG. 5A are shared so that the keys each corresponding to each wireless communication controller are stored into each area. Then, in the authentication processing and the data encryption or decryption processing for each controller, a corresponding key is read and written. However, access to the third area need be allowed only when the authentication processing has been completed correctly. Thus, access from a host device need be inhibited for the case of a key corresponding to a wireless communication controller not having undergone the authentication processing.

Alternatively, the public key areas 108 and the hidden key areas 109 shown in FIGS. 5A and 5B may be prepared in a number equal to the number of wireless communication controllers. Then, each key may be stored in each of the first areas through the fourth areas. In this case, access from the host device to the third area of each area is allowed when the authentication processing to the corresponding wireless communication controller has been completed correctly.

According to the above-mentioned key area configurations, when the areas are shared, the present invention is implemented with reducing the key areas. In contrast, when the areas are prepared respectively for the individual wireless communication controllers, access control to each key is simplified.

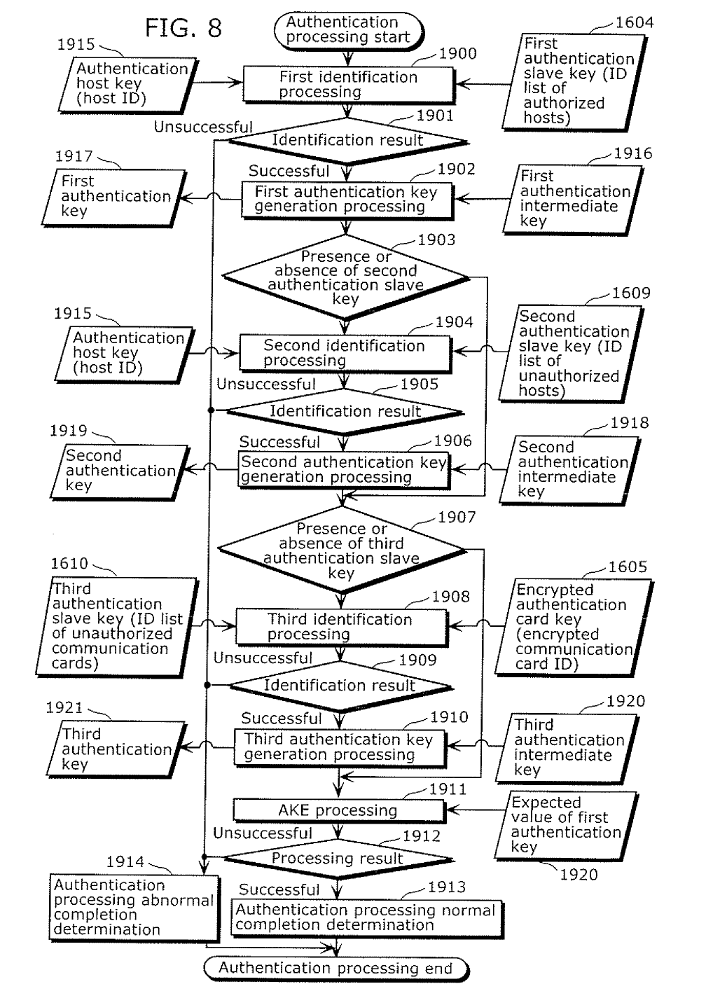

FIG. 8 is a diagram showing a method of the authentication processing, and illustrates further details of the authentication processing of FIG. 6. This authentication processing includes four pieces of processing (the first authentication processing, the second authentication processing, the third authentication processing, and the AKE processing).

With referring to FIG. 8, the first authentication processing 1700 shown in FIG. 6 includes first identification processing 1900, identification result determination 1901, and first authentication key generation processing 1902. Then, as described above, the input to the first authentication processing 1700 is the first authentication slave key 1604 and the authentication host key 1915, while the first authentication intermediate key 1916 is present as an intermediate output. Then, the final output is the first authentication key 1917. Here, the authentication host key 1915 is stored in the key area of the host device in advance.

Here, the first identification processing 1900 of FIG. 8 is processing of identifying whether the authentication host key 1915 which is an identifier proper to the host device is present in the list expressed in the form of the first authentication slave key 1604. Thus, the authentication host key 1915 and the first authentication slave key 1604 are used as the input. Then, in the case of being present in the list, the host device of interest is determined as being authorized. Then, the procedure goes to the first authentication key generation processing 1902. Here, the first authentication intermediate key 1916 is used as the input, and then the first authentication key 1917 is outputted. Although omitted in FIG. 8, the input used in the first authentication key generation processing 1902 is a value (such as a media number) proper to the wireless communication card.

With referring to FIG. 8, the second authentication processing 1702 shown in FIG. 6 consists of second identification processing 1904, identification result determination 1905, and second authentication key generation processing 1906. Then, as described above, the input to the second authentication processing 1702 is the second authentication slave key 1609 and the authentication host key 1915, while the second authentication intermediate key 1918 is present as an intermediate output. Then, the final output is the second authentication key 1919.

Here, the second identification processing 1904 of FIG. 8 is processing of identifying whether the authentication host key 1915 which is an identifier proper to the host device is present in the list expressed in the form of the second authentication slave key 1609. Thus, the authentication host key 1915 and the second authentication slave key 1609 are used as the input. In the case of being present in the list, the host device of interest is determined as an unexpected host device to be revoked. In the case of not being determined as a host device to be revoked, the procedure goes to the second authentication key generation processing 1906. Here, the second authentication intermediate key 1918 is used as the input, and then the second authentication key 1919 is outputted. Although omitted in FIG. 8, the input used in the second authentication key generation processing 1906 is a value (such as a media number) proper to the wireless communication card.

With referring to FIG. 8, the third authentication processing 1704 shown in FIG. 6 includes third identification processing 1908, identification result determination 1909, and third authentication key generation processing 1910. Then, as described above, the input to the third authentication processing 1704 is the encrypted third authentication slave key 1610 and the encrypted authentication card key 1605, while the third authentication intermediate key 1920 is present as an intermediate output. Then, the final output is the third authentication key 1921.

Here, the third identification processing 1908 of FIG. 8 is processing of identifying whether the authentication card key which is an identifier proper to the wireless communication card is present in the list expressed in the form of the third authentication slave key 1610. Thus, the encrypted authentication card key 1605 and the third authentication slave key 1610 are used as the input. Then, in the case of being present in the list, the wireless communication card of interest is determined as an unexpected wireless communication card to be revoked. In contrast, in the case of not being determined as a wireless communication card to be revoked, the procedure goes to the third authentication key generation processing 1910. Here, the third authentication intermediate key 1920 is used as the input, and then the third authentication key 1921 is outputted. Although omitted in FIG. 8, the input used in the third authentication key generation processing 1910 is a value (such as a media number) proper to the wireless communication card.

As such, in the authentication processing of the present invention, the third authentication processing is performed in addition to the first authentication processing and the second authentication processing. For the purpose of this, the authentication card key and the third authentication card key are provided and used in the authentication processing. Thus, according to the authentication processing of the present invention, when an unexpected unauthorized wireless communication card is reported, the device can be revoked.

The third authentication processing shown in FIG. 8 is executed after the first authentication processing or the second authentication processing. In this case, the result of the first authentication processing or the second authentication processing ensures that the host device that executes the third authentication processing is an authorized host device.

In the third authentication processing shown in FIG. 8, the host device performs the determination 1907 of the presence or absence of the third authentication slave key is. Then, when the third authentication slave key is present in the wireless communication card, the third authentication processing is executed. When not present, the third authentication processing is not executed. According to this determination, the third authentication processing is omitted when an unexpected wireless communication card is not reported.

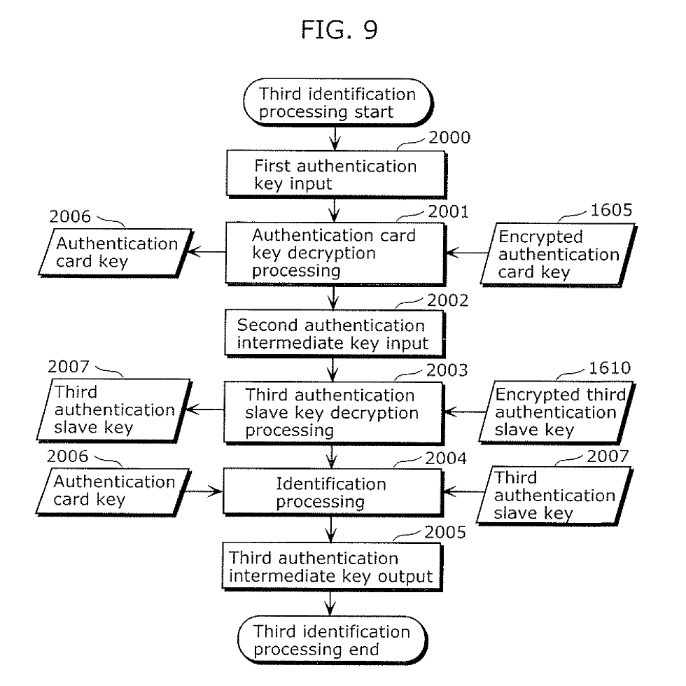

FIG. 9 is a diagram showing a method of the third identification processing, and illustrates further details of the third identification processing 1908 shown in FIG. 8.

The third identification processing includes: processing of generating an authentication card key 2006 from the encrypted authentication card key 1605; processing of generating a third authentication slave key 2007 from the encrypted third authentication slave key 1610; and processing of identifying whether the authentication card key 2006 is a key to be revoked.

Since the encrypted authentication card key 1605 is encrypted in advance with the first authentication key, the processing of generating the authentication card key 2006 from the encrypted authentication card key 1605 includes first authentication key input 2000 and authentication card key decryption processing 2001. Further, since the encrypted third authentication slave key 1610 is encrypted in advance with the second authentication intermediate key in this example, the processing of generating the third authentication slave key 2007 from the encrypted third authentication slave key 1610 consists of second authentication intermediate key input 2002 and third authentication slave key decryption processing 2003. Then, identification processing 2004 is performed, where the third authentication slave key 2007 and the authentication card key 2006 are used as the input. Here, a third authentication intermediate key is generated during the authentication processing.

In the above-mentioned processing method, the encrypted authentication card key 1605 is decrypted with the first authentication key. Thus, the authentication card key is correctly held in the host device only when the host device has correctly executed the first authentication processing so that the first authentication key has been generated.

In the third identification processing shown in FIG. 9, the encrypted third authentication slave key 1610 is decrypted with the second authentication intermediate key. Here, in the case that the second authentication processing is not performed, decryption is performed with the above-mentioned first authentication intermediate key. Thus, the third authentication slave key is correctly held in the host device only when the host device has correctly executed the second authentication processing so that the second authentication intermediate key has been generated, in the case that both of the second authentication processing and the first authentication processing are performed, or alternatively only when the host device has correctly executed the first authentication processing so that the first authentication key has been generated correctly in the case that only the first authentication processing is performed.

In the authentication processing shown in FIG. 8, after the third identification processing 1908, the third authentication key generation processing 1910 is performed by using the third authentication intermediate key 1920 as the input. The third authentication key 1921 generated here is used in decryption processing or encryption processing for the data performed after the completion of the authentication processing. The decryption processing mentioned here corresponds to the data decryption processing 210 by the host device in FIG. 3. The encryption processing corresponds to the data encryption processing 305 by the host device in FIG. 4.

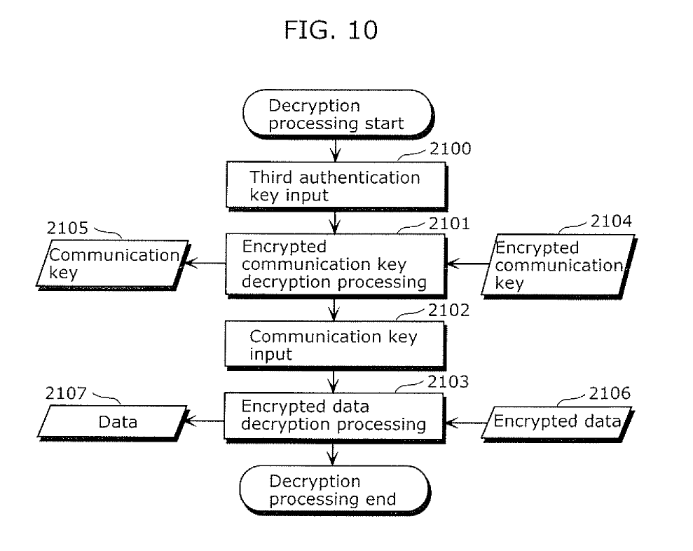

FIG. 10 is a diagram showing a data decryption processing method performed in the host device. The decryption processing shown in FIG. 10 includes: decryption processing for the encrypted communication key stored in the wireless communication card; and decryption processing for the data. In the decryption processing for the encrypted communication key, input 2100 of the third authentication key generated in the third authentication processing is performed first. Then, using this key, decryption processing 2101 is performed on the encrypted communication key 2104 read from the wireless communication card. As a result, a communication key 2105 can be held in the host device. In the decryption processing for the data, input 2102 of the obtained communication key is first performed. Then, using this key, decryption processing 2103 is performed on the encrypted data 2106 transferred from the wireless communication card. As a result, the decrypted data 2107 is obtained in the host device.

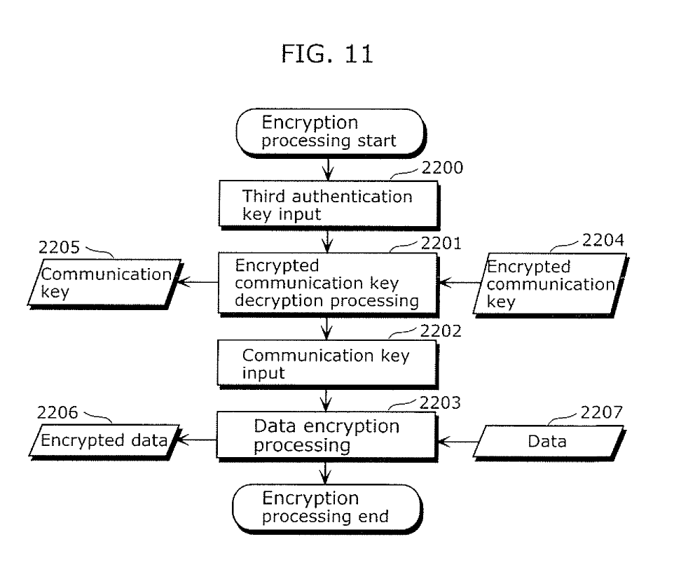

FIG. 11 is a diagram showing a data encryption processing method performed in the host device. Similarly to the decryption processing, in the encryption processing shown in FIG. 11, third authentication key input 2200 for decryption of the encrypted communication key is performed, and then using this key, decryption processing 2201 is performed on the encrypted communication key 2204 so that a communication key 2205 is obtained. Then, communication key input 2202 is performed. Then, using this communication key, encryption processing 2203 of data 2206 is performed, and then encrypted data 2207 is outputted.

As such, the third authentication key is generated in the above-mentioned third authentication processing so that the encrypted communication key stored in the wireless communication card can be decrypted. Here, since the third authentication key generation is performed on the basis of the third intermediate key generated in the third identification processing, only the host device that has correctly executed the third identification processing can generate the third authentication key. Further, only the host device that can generate the third authentication key can perform the decryption processing or the encryption processing for the data using the communication key.

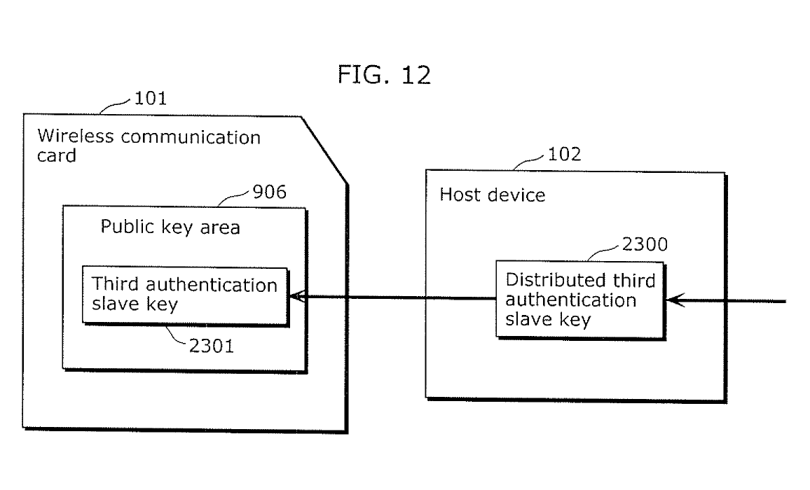

FIG. 12 is a diagram showing update processing for the third authentication slave key.

In the processing shown in FIG. 12, when an unexpected unauthorized wireless communication card is reported, the host device acquires a third authentication slave key 2300 distributed newly, and then stores this third authentication slave key into the public key area 108 of the wireless communication card shown in FIG. 5A. The host device shown in FIG. 12 is assumed to be a device capable of acquiring the third authentication slave key from the outside by means of download or the like. Thus, the host device capable of acquiring the third authentication slave key from the outside 2300 can execute the update processing shown in FIG. 12. Further, the third authentication slave key 2300 is distributed in a form encrypted with the first authentication intermediate key or the second authentication intermediate key.

Here, in a state that an unexpected unauthorized wireless communication card has already been reported, when another unauthorized wireless communication card is reported, a third authentication slave key is newly issued as shown in FIG. 12. The host device transfers this key to the wireless communication card. In this case, a third authentication slave key is already present in the wireless communication card. Thus, the old authentication slave key is replaced by the new third authentication slave key, or alternatively stored together with the new one. When stored together, authentication processing is performed using all the stored third authentication slave keys.

Since the third authentication slave key in the wireless communication card is updated as described above, even when an unexpected unauthorized wireless communication card is newly reported, the newly reported wireless communication card as well as the already reported wireless communication card can be revoked.

In the authentication processing of the present invention, when an unexpected unauthorized host device has been reported, the third authentication slave key 1610 has been encrypted with the second authentication intermediate key. Thus, when another unexpected unauthorized host device is further reported, the host device updates the second authentication slave key. Then, in correspondence to this, the second authentication intermediate key is updated. Thus, when the second authentication intermediate key is updated, in the host device, the third authentication slave key having been encrypted with the not-yet-updated second authentication intermediate key is re-encrypted with the updated third authentication intermediate key. Alternatively, similarly to the case of FIG. 12, a third authentication slave key encrypted with the updated second authentication intermediate key is acquired by means of download or the like, and then the third authentication slave key in the wireless communication card is replaced by the acquired third authentication slave key.

Since the third authentication slave key is updated in accordance with the update of the second authentication slave key as described above, even when an unexpected unauthorized host device is newly reported, the already reported unexpected wireless communication card can be revoked.

As shown in FIG. 12, when the third authentication slave key is updated, the third authentication intermediate key and the third authentication key are updated. Here, the encrypted communication key stored in the third area of the wireless communication card has been encrypted with the not-yet-updated third authentication key. Thus, in order that the decryption of the encrypted communication key shown in FIGS. 10 and 11 should be performed correctly, the communication key need be re-encrypted with the updated third authentication key.

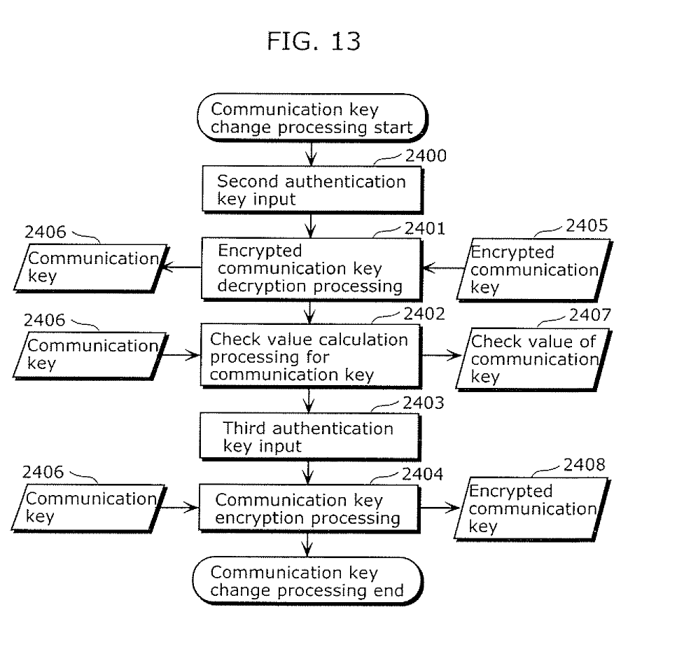

The following example is given for re-encryption processing for the communication key in a case that a third authentication slave key is newly distributed in a state that a second authentication slave key is already present. FIG. 13 shows the re-encryption processing for the communication key in the host device. Here, the re-encryption processing for the communication key shown in FIG. 13 is assumed to be executed after the authentication processing shown in FIG. 8 is performed using the updated third authentication slave key. Thus, the second authentication key and the third authentication key are correctly held in the host.

The re-encryption processing for the communication key shown in FIG. 13 includes: decryption processing for the encrypted communication key encrypted with the second authentication key; check value calculation for the communication key used at the time of writing the communication key into the wireless communication card; and encryption processing for the communication key with the third authentication key. Here, the check value calculation processing for the communication key may be omitted.

In the decryption processing for the encrypted communication key, input 2400 of the second authentication key is performed first. Then, decryption processing 2401 is performed on the encrypted communication key 2405 read from the wireless communication card after the input, so that a communication key 2406 is obtained. Then, calculation processing 2402 for the check value of the communication key is performed. The contents of this processing are described later. After the check value calculation, input 2403 of the third authentication key used for encrypting the communication key is performed. Then, using the inputted key, encryption processing 2404 is performed on the communication key 2406. As a result, an encrypted communication key 2408 is obtained. The host device transfers the encrypted communication key 2408 to the wireless communication card, and then stores the key as a new encrypted communication key.

As such, re-encryption processing is performed on the communication key. By virtue of this, even when the third authentication slave key is updated, the encrypted communication key can be decrypted correctly in the subsequent execution of the authentication processing using the updated third authentication slave key.

In the confidential information processing system of the present invention, as shown in FIG. 5B, the communication key used by the wireless communication card is stored in the second area 1601, while the communication key used by the host device is stored in the third area 1602. Thus, when the host device writes the encrypted communication key into the third area 1602, if a communication key having a different value from the communication key having stored in the second area 1601 were written, encryption and decryption processing for the data would be performed using two mutually different communication keys between the wireless communication card and the host device in the subsequent encryption processing and decryption processing for the data. Thus, the data could not be transferred correctly.

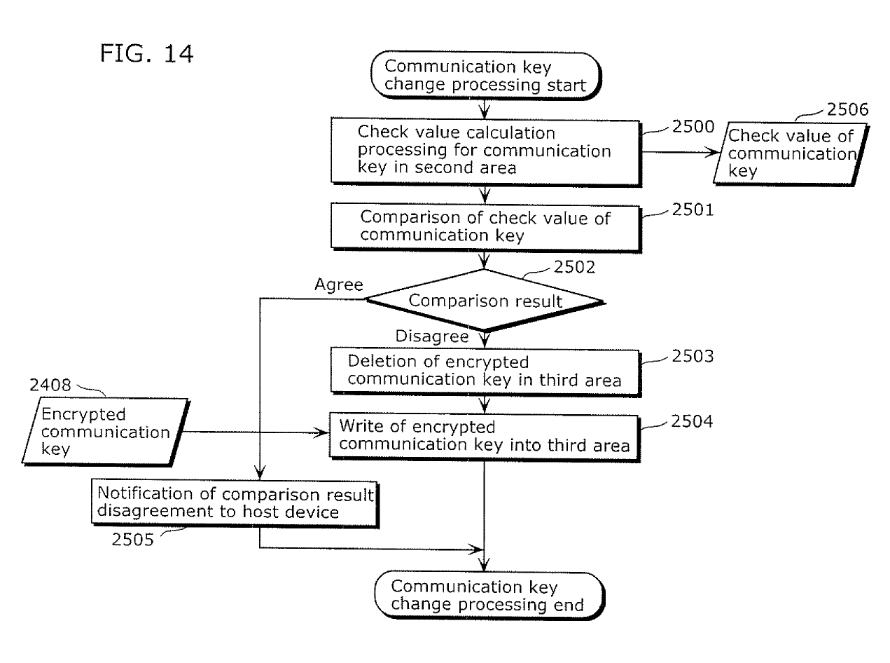

Thus, the check value of the communication key shown in FIGS. 13 and 14 is used and thereby prevents a communication key having a value different from that on the wireless communication card from being stored. This processing is not indispensable. That is, the host device may be allowed to replace the communication key without using the check value.

FIG. 14 shows a processing method performed in the wireless communication card when the encrypted communication key stored in the third area is replaced. This processing includes: check value calculation for the communication key stored in the second area of the wireless communication card; comparison of the calculated check value with the check value of the encrypted communication key transferred from the host device; and processing performed when the check result is agreement or not agreement. Here, an example of employable check value is a CRC (Cyclic Redundancy Check) value. However, another check value may be adopted so that this processing may be implemented by a similar method.

In the processing method of FIG. 13, check value calculation processing 2402 for the communication key of the host device is performed so that a check value 2407 is calculated. The host device transfers this check value to the wireless communication card. On the other hand, in the processing performed by the wireless communication card shown in FIG. 14, check value calculation processing 2500 for the communication key in the second area is performed first, and then this check value 2506 is held. Then, the check value of the communication key transferred from the host device is compared with the calculated check value 2506 of the communication key. When the values agree with each other in comparison result 2502, the wireless communication card performs: encrypted communication key deletion 2503 in the third area; and encrypted communication key write 2504 into the third area. As a result, the encrypted communication key is replaced. In contrast, when the values do not agree with each other in comparison result 2502, notification 2505 of the disagreement comparison result is performed to the host device. In this case, encrypted communication key write is not performed.

As such, in the write of the encrypted communication key into the wireless communication card, check values of the communication keys are used. This prevents a value of the communication key used in the wireless communication card from being different from a value of the communication key used in the host device.

In the confidential information processing system of the present invention, after the completion of authentication processing between the wireless communication card and the host device, the values of the communication key used by the wireless communication card and the communication key used by the host device can be replaced. In the case that the values of the communication keys are replaced for each authentication processing, even when the same data is transferred, the data transferred between the wireless communication card and the host device has a different value in each authentication processing. However, the above-mentioned replacement of the communication keys is not indispensable. That is, the same communication keys may be used in the entire authentication processing.

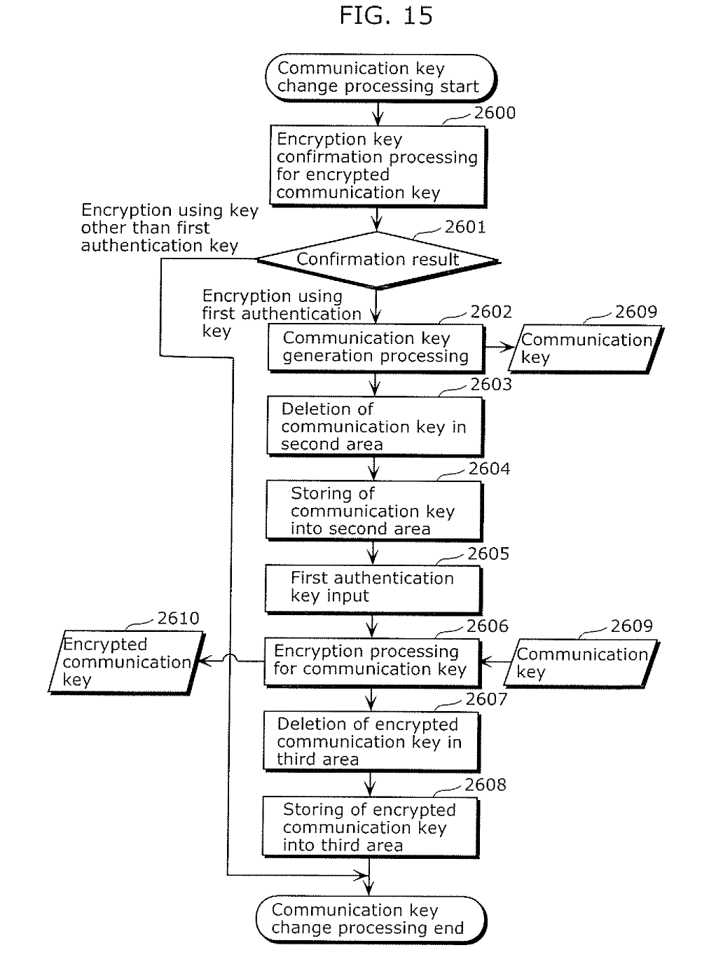

FIG. 15 show a processing method of replacement of the value of the communication key. Here, the replacement of the value is executed only when the encrypted communication key stored in the third area is encrypted with the first authentication key and then stored. The processing method shown in FIG. 15 includes: processing of confirming whether the encrypted communication key stored in the third area is being encrypted with the first authentication key or another key; generation processing for a new communication key; replacement processing for the communication key in the second area; and replacement processing for the encrypted communication key in the third area.

The processing of confirming the key adopted in the encryption of the encrypted communication key is indicated by encryption key confirming processing 2600 for the encrypted communication key in FIG. 15. As a result of this processing, when the encrypted communication key is confirmed as being encrypted with the first authentication key, generation processing and replacement processing for the communication key are performed. When confirmed as being encrypted with a key other than the first authentication key, it is concluded that the communication key cannot be decrypted within the wireless communication card. This is because the second authentication key and third authentication key are not held in the wireless communication card. In this case, the processing is terminated without changing the value.

When encryption is performed with the first authentication key, communication key generation processing 2602 is performed in the wireless communication card so that a new communication key 2609 is generated. After the generation, communication key deletion 2603 for the second area and communication key storing 2604 into the second area are performed so that the communication key in the second area is replaced into the new communication key 2609. Then, when the communication key is stored into the third area, input 2605 of the first authentication key and encryption processing 2606 for the communication key are performed so that the new communication key 2609 is encrypted with the first authentication key. Here, the encryption circuit in the wireless communication card is used. After the encryption, encrypted communication key deletion 2607 for the third area and encrypted communication key storing 2608 into the third area are performed so that the encrypted communication key in the third area is replaced into the new encrypted communication key 2610.

As such, the communication key is replaced into a new value after the authentication processing, so that different communication keys are used in each authentication processing. This improves the confidentiality in the data transferred between the wireless communication card and the host device.

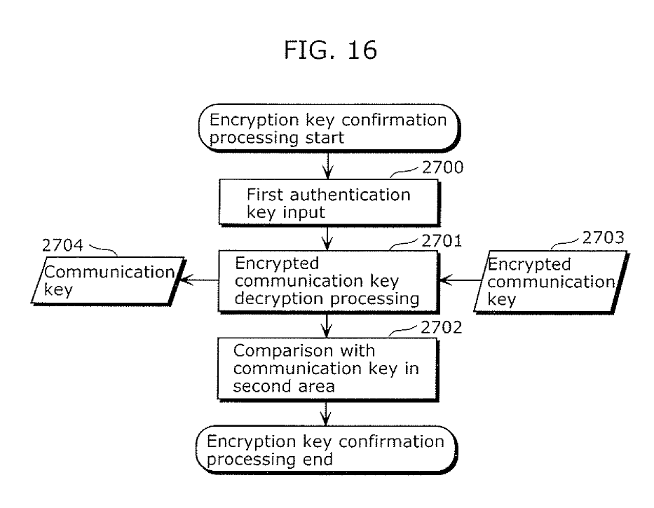

FIG. 16 is a diagram showing the contents of the processing of encryption key confirming processing 2600 for the encrypted communication key shown in FIG. 15. In this processing, the encrypted communication key stored in the third area is decrypted with the first authentication key, and then it is confirmed whether the result agrees with the communication key stored in the second area. Thus, as shown in FIG. 16, input 2700 of the first authentication key is performed, and then the encrypted communication key 2703 in the third area is decrypted in decryption processing 2701. Then, in comparison 2702 with the communication key in the second area, it is confirmed whether the decrypted key is that having been encrypted with the first authentication key.

As such, when decryption with the first authentication key is tried on the encrypted communication key in the third area, it can be confirmed whether the key used in the encryption of the encrypted communication key is the first authentication key.

The processing shown in FIG. 16 may be implemented in the following processing. When the encrypted communication key in the third area is encrypted with the second authentication key or the third authentication key, the second authentication slave key or the third authentication slave key is stored in the fourth area. Thus, the key used in the encryption of the encrypted communication key stored in the third area can be confirmed on the basis of determination whether the second authentication slave key or the third authentication slave key is stored or not in the fourth area.

In the communication key generation processing 2602 in FIG. 15, the value of the generated communication key is determined according to a random number generated in the wireless communication card in order that the value of the generated communication key should have a different value in each authentication processing. This prevents the value of the generated communication key from being inferred.

### Embodiment 2

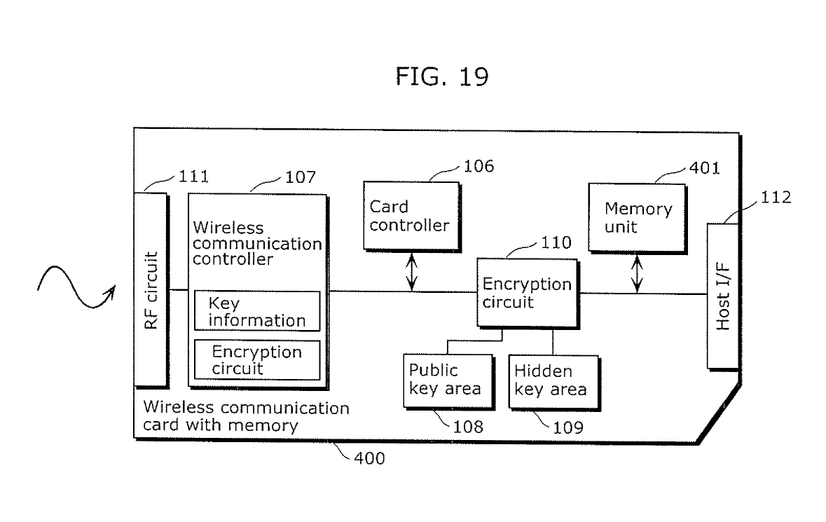

FIG. 19 is a diagram showing a configuration of a wireless communication card having a memory function according to Embodiment 2.

The wireless communication card 400 having a memory function of FIG. 19 (referred to as a “memory-equipped wireless communication card”, hereinafter) is constructed by adding a memory unit 401 for storing data, to the wireless communication card 101 shown in FIG. 2. Here, the other components of FIG. 19 are designated by like numerals to the components of FIG. 2. Hence, their description is omitted. Here, the data distribution terminal and the host device are omitted in FIG. 19. However, similarly to the case of FIG. 2, confidential data transfer is performed using these components.

Since the memory-equipped wireless communication card 400 of FIG. 19 is provided with the memory unit 401, data transferred in the data transfer can be stored within the memory-equipped wireless communication card 400. In the case that the data is received from the data distribution terminal, the data stored here is in a form encrypted by the encryption circuit 110 in the card. In contrast, in the case of sending the data, the data stored here is in a form encrypted by the encryption circuit of the host device. However, in the memory-equipped wireless communication card 400 of FIG. 19, data storing by using the memory unit 401 is no indispensable. That is, a data transfer method similar to that of the confidential information processing system shown in FIG. 2 may be adopted.

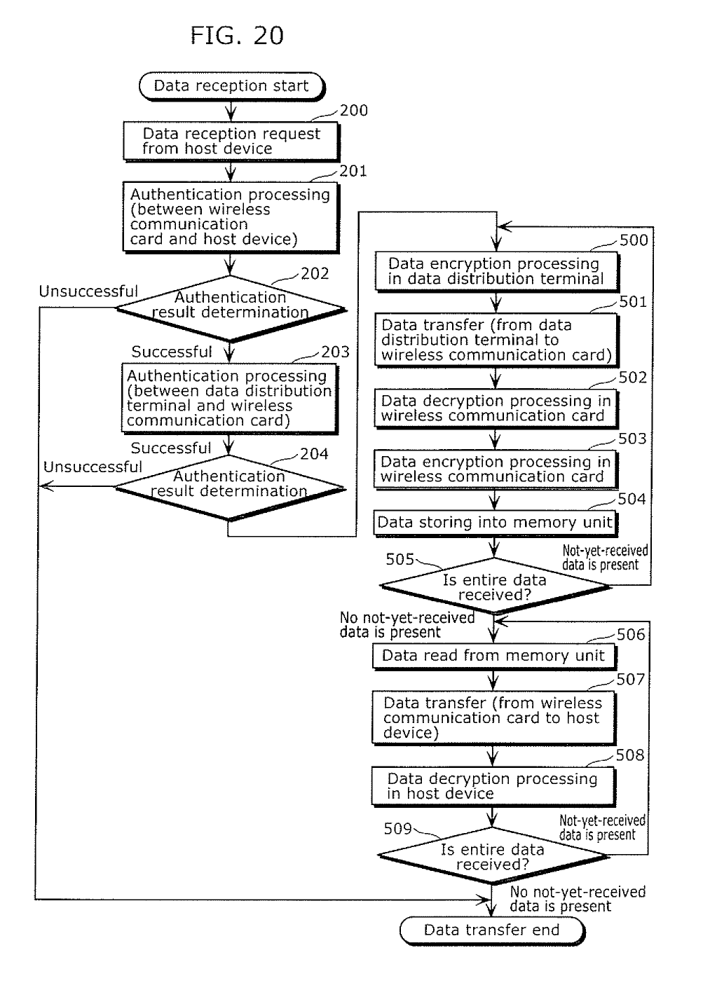

FIG. 20 is a diagram showing a processing method performed when using the memory-equipped wireless communication card 400 of FIG. 19, the host device receives encrypted data from the data distribution terminal. Here, the authentication processing used here is similar to that of the confidential information processing system shown in FIG. 2. Thus, the authentication processing is assumed to have been completed normally in this example. In the following description, the operation of data reception in the confidential information processing system of FIG. 19 is explained with reference to FIG. 20.

In this case, first, encryption processing 500 for the data is performed by the data distribution terminal. After that, the data is transferred to the memory-equipped wireless communication card 400. After the data reception, in the wireless communication card 400, the wireless communication controller 107 performs decryption processing 502. Then, for the purpose of transmission to the host device, the encryption circuit 110 performs encryption processing 503. Here, the key and the processing method used in the encryption processing are the same as those of the wireless communication card without a memory function. After the encryption processing, in the wireless communication card 400 shown in FIG. 19, the encrypted data can be stored into the memory unit 401. Then, when the entire data to be received has been stored into the memory-equipped wireless communication card 400, the host device 102 can receive the data. After that, the host device 102 starts data read 506 from the memory unit 401. After the reception, decryption processing 508 is performed in the host device 102.

Here, in the above-mentioned processing, the data read from the host device 102 need not be performed immediately after the data storing into the memory unit 401 of the memory-equipped wireless communication card 400. That is, the data may be read at an arbitrary time. Further, the data stored in the wireless communication card 400 remains intact in the memory unit 401 of the wireless communication card 400 even after being read out from the host device 102. Thus, the host device having performed the authentication processing can re-read the data.

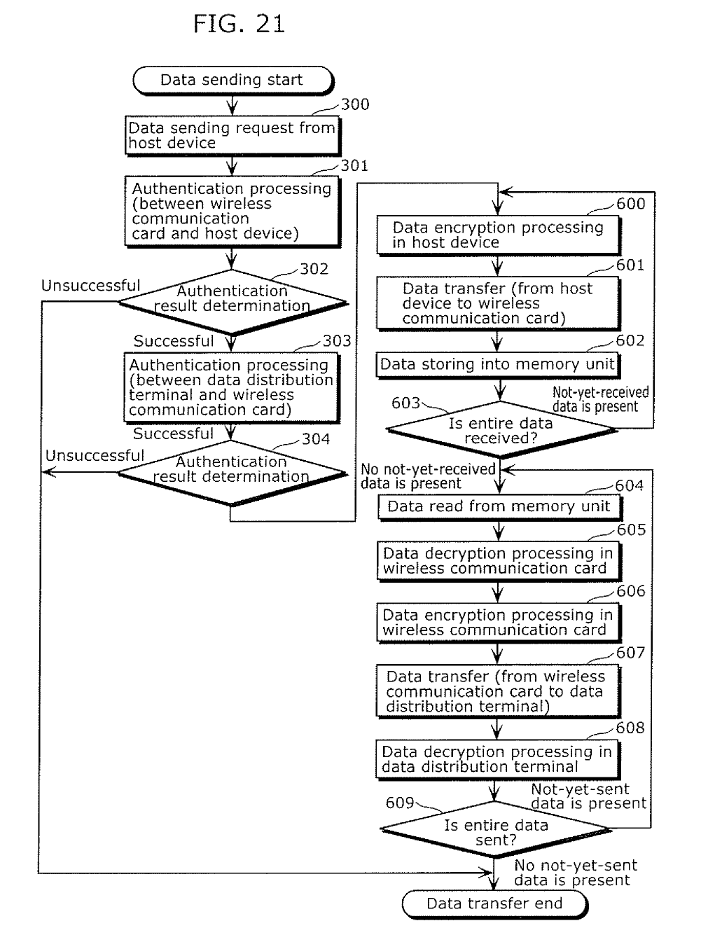

FIG. 21 is a diagram showing a processing method performed when using the memory-equipped wireless communication card 400 of FIG. 19, the host device sends encrypted data to the data distribution terminal. The authentication processing is assumed to have been completed normally also in this example. In the following description, the operation of data sending in the confidential information processing system of FIG. 19 is explained with reference to FIG. 21.

When encrypted data is sent from the host device 102, encryption processing 600 is first performed in the host device 102. Then, the encrypted data is transferred to the memory-equipped wireless communication card 400. After the data reception, in the memory-equipped wireless communication card 400, the received data can be stored into the memory unit 401. When the entire data to be sent has been stored, the memory-equipped wireless communication card 400 starts data read 604, and then the encryption circuit 110 performs decryption processing 605 on the data. Then, for the purpose of transfer to the data distribution terminal 100, the communication controller 107 performs encryption processing 606. The encrypted data is transferred to the data distribution terminal 100. After the transmission, the data distribution terminal 100 performs decryption processing 608.

Here, similarly to the case of data reception, the data read by the data distribution terminal 100 need not be performed immediately after the data storing into the memory unit 401 of the memory-equipped wireless communication card 400. That is, the data may be read at an arbitrary time. Further, the data stored in the memory-equipped wireless communication card 400 remains intact in the memory unit 401 of the memory-equipped wireless communication card 400 even after being read out from the data distribution terminal 100. Thus, the data distribution terminal having performed the authentication processing can re-read the data.

As such, when the memory-equipped wireless communication card shown in FIG. 19 is employed, data can be accumulated in the memory unit in the confidential information processing system shown in FIG. 2. This allows the host device 102 and the data distribution terminal 100 to read the data at an arbitrary time. Further, the data in the memory-equipped wireless communication card 400 is retained in a readable state unless deleted. Thus, the host device 102 and the data distribution terminal 100 can re-read the data. Furthermore, the data stored in the memory-equipped wireless communication card 400 is encrypted by the encryption method used between the memory-equipped wireless communication card 400 and the host device 102. This prevents an unauthorized device not having undergone authentication processing from reading the data.

In the confidential information processing system of FIG. 2, in some cases, even in the data transfer using the wireless communication controller 107, not entire data requires encryption, that is, a part of data does not require encryption. In such a case, between these devices, data that requires encryption is encrypted, whereas data that does not require encryption is not encrypted.

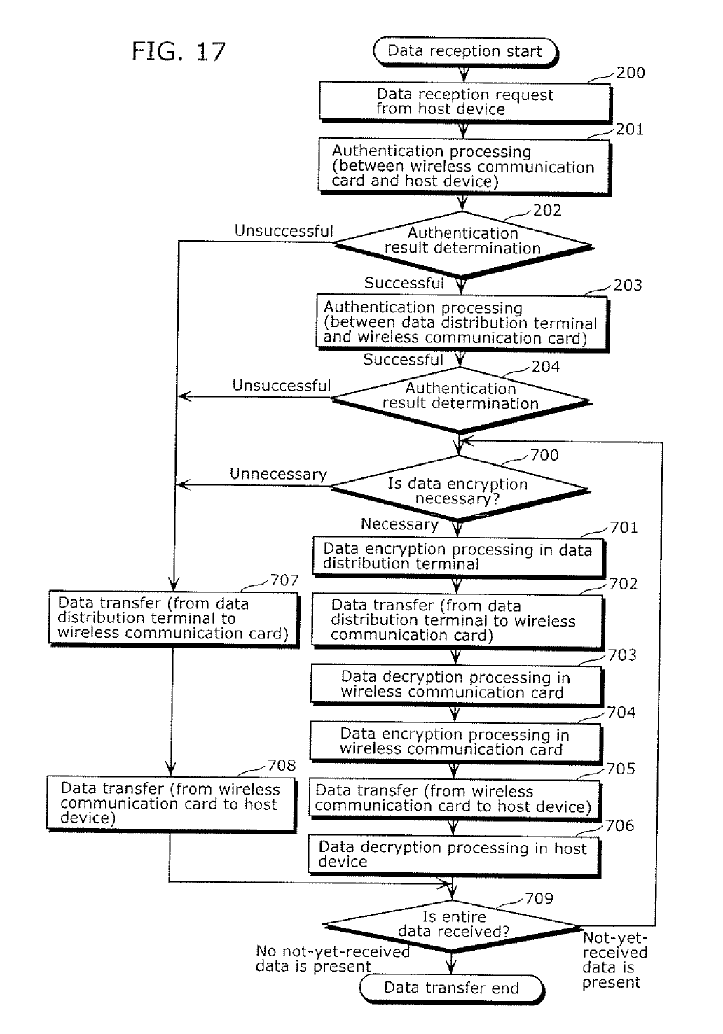

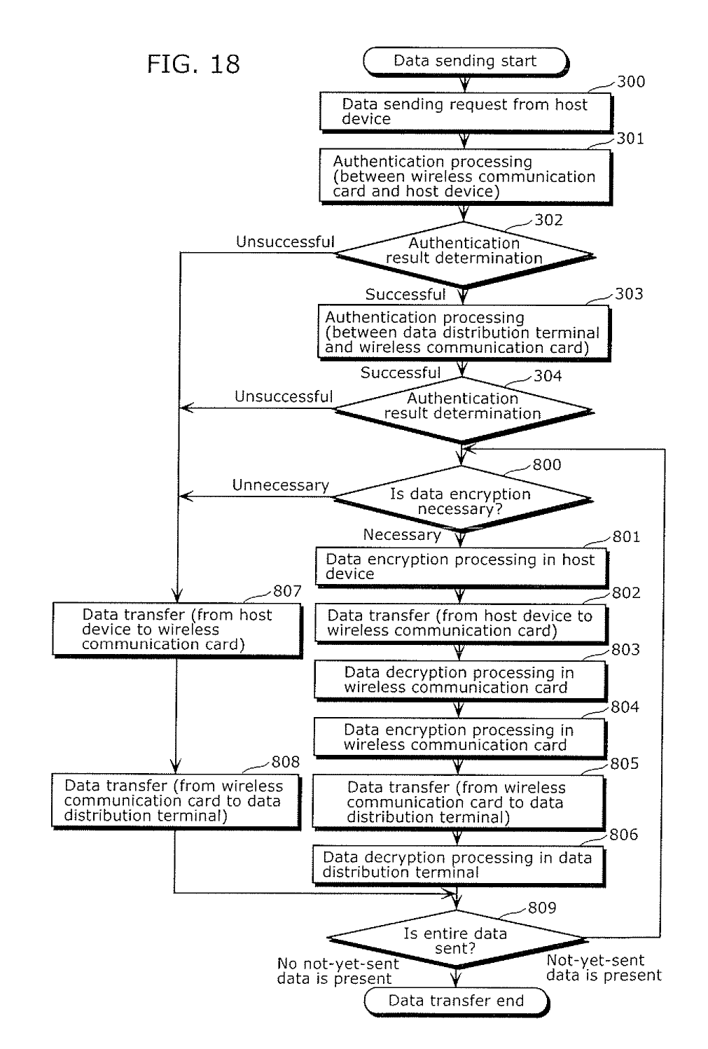

FIGS. 17 and 18 show this processing method. FIG. 17 shows a processing method performed at the time of data reception after the authentication processing. FIG. 18 shows a processing method performed at the time of data sending after the authentication processing. Here, even when the memory-equipped wireless communication card shown in FIG. 19 is employed, the only difference is that the storing into the memory unit is performed or not. Thus, whether encryption is to be performed can be selected by the same method.

At the time of data reception, when the data is transferred from the data distribution terminal to the wireless communication card, determination 700 is performed whether encryption is necessary for each data. In the case of data that requires encryption, encryption is performed by the data distribution terminal in data encryption processing 701, and then data transfer is performed using the wireless communication controller. Thus, after the data reception, in the wireless communication card, data encryption processing 704 is performed, and then data transfer to the host device is performed. In contrast, in the case of data that does not require encryption, non-encrypted data transfer 707 from the data distribution terminal is performed by the wireless communication controller. Thus, in the wireless communication card, the wireless communication controller on the card side receives this data. Then, after the reception, non-encrypted data transfer 708 to the host device is performed.

In order to perform such processing, the wireless communication card need have a configuration including a data path detouring the encryption circuit Data flow in the wireless communication card performed in the confidential information processing system of the present invention when encryption is not performed is described later.

At the time of data sending, when the data is transferred from the host device to the wireless communication card, determination 800 is performed whether encryption is necessary for each data. In the case of data that requires encryption, data encryption processing 801 is performed by the host device, so that encrypted data is transferred to the wireless communication card. Then, in the wireless communication card, the wireless communication controller performs encryption processing 804, and then the wireless communication controller performs data transfer. In contrast, in the case of data that does not require encryption, non-encrypted data transfer 807 is performed from the host device. Thus, non-encrypted data transfer 808 is performed also in the wireless communication card.

As such, in the case of data that requires encryption, encryption is performed between the devices, whereas data that does not require encryption is not encrypted. This reduces processing in the data transfer in the case that a part of data does not require encryption.

### Embodiment 3

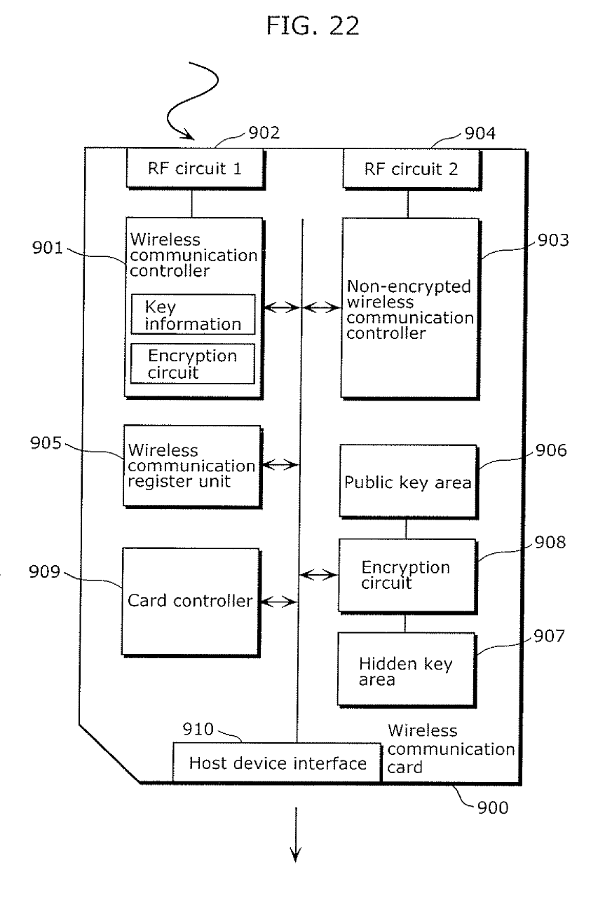

FIG. 22 is a diagram showing a configuration of a wireless communication card 900 according to Embodiment 3. Here, the wireless communication card 900 of FIG. 22 shows further details of the configuration of the wireless communication card 101 in the confidential information processing system of FIG. 2.

The wireless communication card 900 comprises: a wireless communication controller 901 which is a circuit for performing encrypted wireless communication; an RF circuit 1 (902) used as a is radio antenna by the controller; a wireless communication controller 903 (referred to as a “non-encrypted wireless communication controller”, hereinafter) which is a circuit for performing non-encrypted wireless communication only; an RF circuit 2 (904) used as a radio antenna by the controller; a wireless communication register unit 905 which is an area for storing information necessary for control of the wireless communication controller 901 and the non-encrypted wireless communication controller 903; a public key area 108 that stores a key used for performing authentication processing with the host device and that can be accessed from the host device without authentication processing; a hidden key area 109 which is an area that stores a key used for encrypting data transferred to and from the host device and that can be accessed from the host device only when the authentication processing has been completed normally; an encryption circuit 908 which is a circuit for performing data encryption with the host device; a card controller 909 which is a circuit for controlling the wireless communication card 900; and a host device interface 910 for performing interface control with the host device.

Here, in FIG. 22, a single unit of the wireless communication controller and a single unit of the non-encrypted wireless communication controller are present in the wireless communication card. However, a plurality of these units may be present. Further, the non-encrypted wireless communication controller need not be present within the wireless communication card.

When data transfer using the encryption shown in FIGS. 3 and 4 is performed through the wireless communication card 900 shown in FIG. 22, the following control is performed in the wireless communication card 900. First, when the authentication processing with the host device is not completed normally, the wireless communication card 900 does not allow the host device to access the hidden key area 109 and use the wireless communication controller 901. When the host device is determined as an authorized device in the authentication processing, the host device is allowed to access the hidden key area 109 and use the wireless communication controller 901. Thus, the host device can perform data transfer using the wireless communication controller 901.

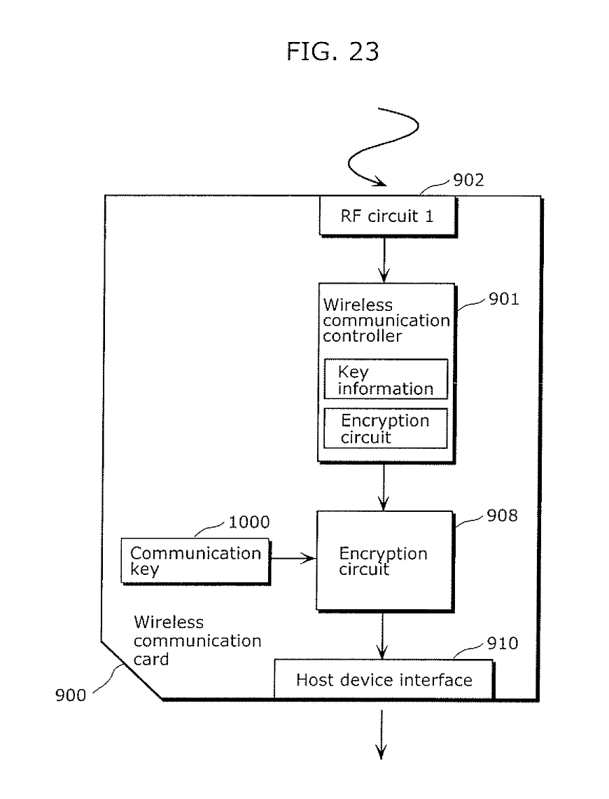

Next, FIG. 23 shows data flow in the wireless communication card 900 in the case that data transfer is performed after the authentication processing by using the wireless communication controller 901. Here, the components of FIG. 23 are designated by like numerals to the components of FIG. 22. When encrypted data is received, as shown in FIG. 23, the data received by the wireless communication controller 901 through the RF circuit 1 (902) is always inputted to the encryption circuit 908, and then encrypted with a key referred to as a communication key 1000 which is a key used for encrypting the data stored in the hidden key area. Then, the data outputted from the encryption circuit 908 is transferred to the host device through the host device interface 910.

When the encrypted data is sent to the data distribution terminal, after encrypted in the host device, the data having been transferred through the host device interface 910 is always inputted to the encryption circuit 908 and then decrypted with the communication key 1000. Then, the decrypted data is encrypted by the wireless communication controller 901 and then transferred through the RF circuit 1 (902).

According to the wireless communication card having the above-mentioned configuration, data transfer with the data distribution terminal is allowed only when the host device is recognized as an authorized device. This prevents unauthorized data transfer by an unauthorized host device. Further, in the data transfer after the authentication processing, the data transferred between the host device and the data distribution terminal is encrypted so that confidentiality is achieved in the transferred data.

### Embodiment 4

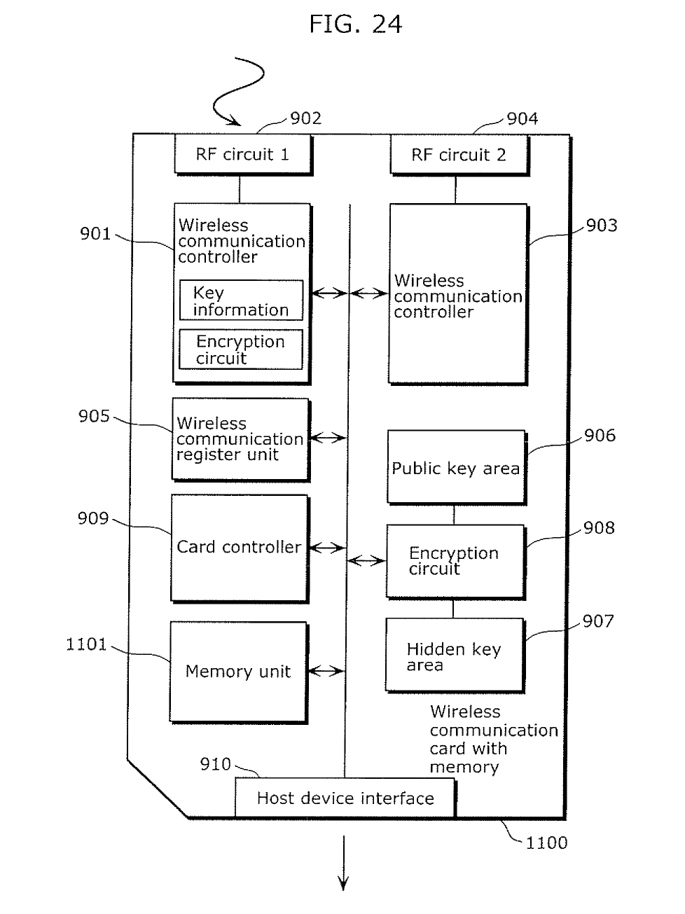

FIG. 24 is a diagram showing a configuration of a memory-equipped wireless communication card 1100 according to Embodiment 4. Here, the wireless communication card 1100 of FIG. 24 shows further details of the configuration of the memory-equipped wireless communication card 400 in the confidential information processing system of FIG. 19.

In the memory-equipped wireless communication card 1100 of FIG. 24, a memory unit 1101 for storing data is added to the wireless communication card 900 shown in FIG. 22. When this configuration is employed, in the data transfer using the wireless communication controller, the data can be stored into the memory unit 1101.

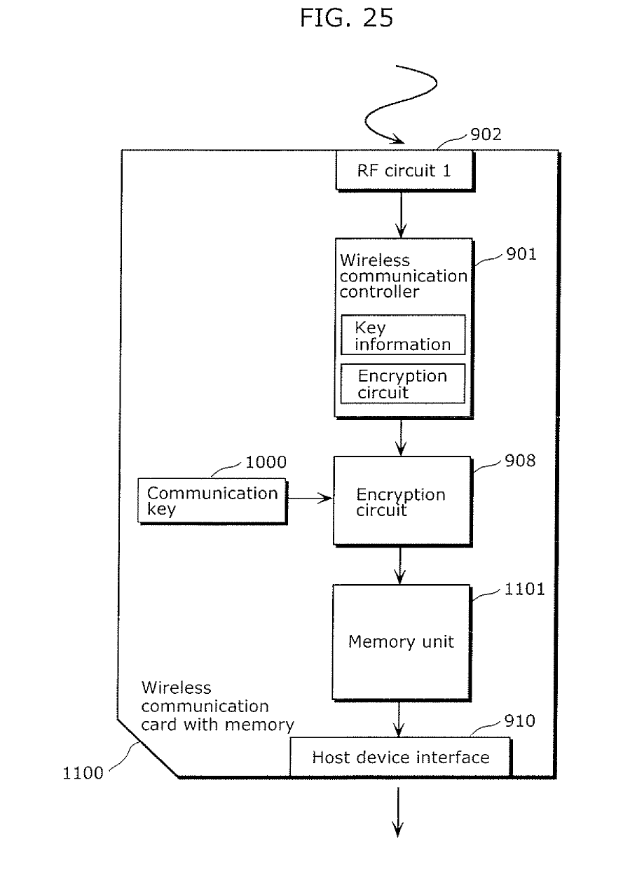

FIG. 25 is a diagram showing data flow for the case that the data is received from the data distribution terminal by using the memory unit 1101. Here, the components of FIG. 25 are designated by like numerals to the components of FIG. 24. As shown in FIG. 25, the data received by the wireless communication controller 901 through the RF circuit 1 (902) is inputted to the encryption circuit 908, and then encrypted with the communication key 1000 described above. After that, the encrypted data is stored into the memory unit 1101. Here, the stored data is held intact by the memory-equipped wireless communication card 1100 unless deleted. After the storing, when data read is performed by the host device, the data is outputted from the memory unit 1101 and then transferred to the host device through the host device interface 910.

Here, in the memory-equipped wireless communication card 1100 of FIG. 24, data reception without data storing may also be performed depending on a setting from the host device. In this case, the data flow becomes similar to that shown in FIG. 23.

When data is to be sent to the data distribution terminal, the data having been transferred from the host device through the host device interface 910 is stored into the memory unit 1101. Here, the stored data is held intact by the memory-equipped wireless communication card 1100 unless deleted. After the storing, when data read is performed from the data distribution terminal, the data is outputted from the memory unit 1101. Then, the data is inputted to the encryption circuit 908 and then decrypted with the communication key. After that, the data is encrypted by the wireless communication controller 901 and then transferred to the data distribution terminal through the RF circuit 1 (902). Here, also in the data sending, transfer without data storing may also be performed.

As such, when the memory-equipped wireless communication card 1100 shown in FIG. 24 is employed, data can be stored in the memory unit 1101. This allows the host device and the data distribution terminal to read the data at an arbitrary time. Further, the data in the memory-equipped wireless communication card is held in a readable state unless deleted. Thus, the host device and the data distribution terminal can re-read the data. Further, the data stored in the memory-equipped wireless communication card is stored in an encrypted form. This prevents an unauthorized device from reading the data.

As shown in FIGS. 22 and 24, in the case that the non-encrypted wireless communication controller 903 is present within the card, the wireless communication card and the memory-equipped wireless communication card allow the host device to use the non-encrypted wireless communication controller 903 without authentication processing. Thus, the host device can use the non-encrypted wireless communication controller 903 without authentication processing.

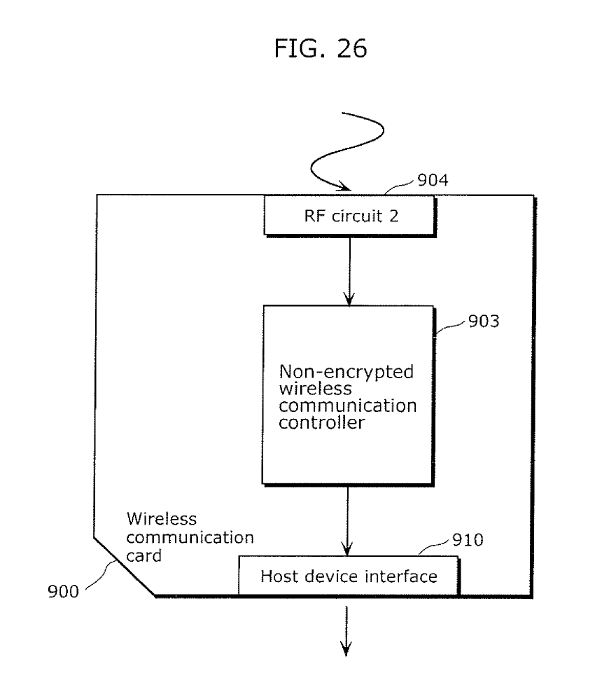

FIG. 26 shows data flow for the case that the wireless communication card receives data through the non-encrypted wireless communication controller 903. In data reception, as shown in FIG. 26, the data received by the non-encrypted wireless communication controller 903 through the RF circuit 2 (904) is transferred to the host device through the host device interface 910 without being inputted to the encryption circuit. In data sending through the non-encrypted wireless communication controller 903, the data transferred from the host device through the host device interface 910 is inputted to the non-encrypted wireless communication controller 903 and then transferred through the RF circuit 2 (904).

Here, in the memory-equipped wireless communication card shown in FIG. 24, even when the non-encrypted wireless communication controller 903 is used, data storing can be performed. When the data is to be stored, in FIG. 26, data storing by the memory unit is performed between the non-encrypted wireless communication controller 903 and the host device interface 910.

Further, as described above, even in the case of data transfer by the wireless communication controller 901, the wireless communication card and the memory-equipped wireless communication card do not encrypt data that does not require encryption. In this case, data flow within the wireless communication card and the memory-equipped wireless communication card is similar to that shown in FIG. 26.

According to the wireless communication card having the above-mentioned configuration, when the non-encrypted wireless communication controller is used, the host device can use the non-encrypted wireless communication controller without authentication processing. Thus, the data to be transferred can be transferred without processing encryption in the wireless communication card.

In the wireless communication card showing in FIG. 22 and the memory-equipped wireless communication card shown in FIG. 24, a plurality of wireless communication controllers can be present in some cases. In such a case, authentication processing proper to each wireless communication controller is prepared for the host device. Then, only when each authentication processing has been completed normally, the use of each wireless communication controller is allowed. Here, an individual public key area is prepared so that authentication processing is executed using each. Further, in the data transfer with the host device after the authentication processing, the data is transferred using a key stored in the individual hidden key area as well as an individual encryption circuit.

According to the wireless communication card having the above-mentioned configuration, data transfer using each wireless communication controller can be performed only when authentication processing corresponding to each wireless communication controller is performed for the host device. This improves the confidentiality of data even in the case that a plurality of wireless communication controllers are present in the wireless communication card.

In the wireless communication card showing in FIG. 22 and the memory-equipped wireless communication card shown in FIG. 24, a plurality of wireless communication controllers are assumed to be present in the following description. In this case, a single kind of authentication processing may be prepared for the host device. Then, when the authentication processing has been completed normally, the use of all wireless communication controllers may be allowed. Here, a single public key area is prepared so that authentication processing is executed using this. Further, in data transfer with the host device after the authentication processing, decrypted data is transferred using the common key and the common encryption circuit.

According to the wireless communication card having the above-mentioned configuration, only a single kind of authentication processing is necessary, and hence a single public key area, a single hidden key area, and a single encryption circuit are used. This reduces the time of authentication processing and the sizes of the key area and the encryption circuit even in the case that a plurality of wireless communication controllers are present in the card.

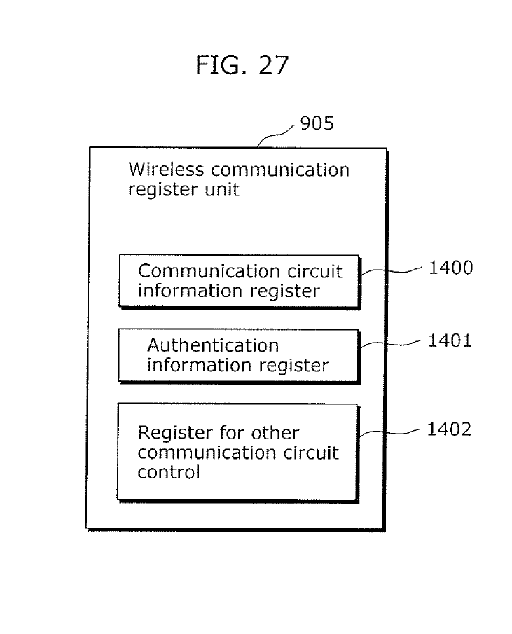

FIG. 27 is a diagram showing a configuration of the wireless communication register unit 905.

The wireless communication register unit 905 is present within the wireless communication card or the memory-equipped wireless communication card and comprises: a communication circuit information register 1400 which is a register used for displaying or setting up information concerning the wireless communication controller and the non-encrypted wireless communication controller; an authentication information register 1401 which is a register used for displaying or setting up information concerning the authentication processing between the wireless communication card and the host device which is necessary in a case that the wireless communication controller is used; and a register 1402 for other communication circuit control which is a register used for displaying or setting up information concerning the other communication circuits.

Here, the three registers are in the form of three independent registers in the present embodiment. However, this configuration is arbitrary.

In the confidential information processing system of the present invention, when the host device uses the wireless communication controller of the wireless communication card or the memory-equipped wireless communication card, authentication processing is required between the host device and the card. In contrast, when the non-encrypted wireless communication card is to be used, authentication processing is unnecessary. Thus, the host device need recognize whether the wireless communication controller to be used requires authentication processing. Accordingly, in the communication circuit information register 1400 shown in FIG. 27, bits are prepared for notifying to the host device whether authentication processing is necessary when the host device uses a wireless communication controller.

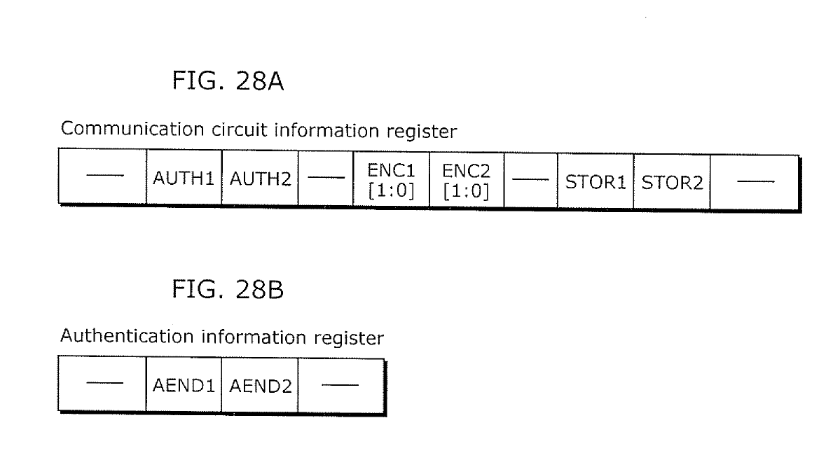

FIG. 28A shows an example of configuration of the communication circuit information register 1400 shown in FIG. 27. This example shows a register configuration in the memory-equipped wireless communication card 1100. As described later, when the register configuration in the wireless communication card 900 is considered, STOR1 and STOR2 of the communication circuit information register 1400 are omitted.

Here, bits denoted respectively by AUTH1 and AUTH2 in the communication circuit information register 1400 indicate the necessity or non-necessity of authentication processing. Each of AUTH1 and AUTH2 is composed of a single bit and is read-only from the host device. AUTH1 indicates information concerning the wireless communication controller 901 in the memory-equipped wireless communication card 1100, while AUTH2 indicates information concerning the non-encrypted wireless communication controller 903. Thus, in the case that n wireless communication controllers are present in the wireless communication card, n bits ranging from AUTH1 to AUTHn are present. Here, it is assumed that each bit of 1 indicates that authentication processing is required in the use of the corresponding wireless communication controller. In contrast, each bit of 0 indicates that authentication processing is not required in the use of the corresponding wireless communication controller. The assignment of 0 and 1 may be reversed. In the case of the memory-equipped wireless communication card of FIG. 24, authentication processing is necessary for the wireless communication controller 901. Thus, AUTH1 is set to be 1. In contrast, authentication processing is unnecessary for the non-encrypted wireless communication controller 903. Thus, AUTH2 is set to be 0. When reading these bits, the host device can recognize the presence or absence of the authentication processing.

According to the registers having the above-mentioned configuration, the host device can be notified whether authentication processing is necessary in the use of each wireless communication controller.

In the confidential information processing system of the present embodiment, even in the data transfer using the wireless communication controller, data that does not require encryption is not encrypted. Thus, when data is received from the data distribution terminal, the host device need be notified whether each data is in an encrypted form. Further, when data is sent to the data distribution terminal, the host device need notify whether each data is in an encrypted form. Thus, in the communication circuit information register 1400 shown in FIG. 27, bits are prepared for displaying or setting up whether encryption is necessary to each data.

FIG. 28A shows an example of configuration of the communication circuit information register 1400 shown in FIG. 27. Here, bits denoted by ENC1 and ENC2 in the communication circuit information register 1400 display or set up the necessity or non-necessity of encryption. Each of ENC1 and ENC2 is composed of 2 bits. A bit ENC1[1] serving as the higher order bit of ENC1 and a bit ENC2[1] serving as the higher order bit of ENC2 can be read and written from the host device. Further, a bit ENC1[0] and a bit ENC2[0] serving as the lower order bits of ENC1 and ENC2 are read-only from the host device. Furthermore, ENC1 indicates information concerning the wireless communication controller 901 in the memory-equipped wireless communication card 1100, while ENC2 indicates information concerning the non-encrypted wireless communication controller 903. Thus, in the case that n wireless communication controllers are present in the wireless communication card, 2×n bits ranging from ENC1 to ENCn are present.

Here, as for the data reception from the data distribution terminal, in the case that the data is received through the wireless communication controller 901, ENC1[0] is set to be 1 when encryption has been performed on a particular data. This causes the host device to recognize that the data is to be received in an encrypted form. In contrast, when encryption has not been performed, ENC1[0] is set to be 0. This causes the host device to recognize that the data is to be received in a non-encrypted form. The assignment of 0 and 1 may be reversed. When data is received through the non-encrypted wireless communication controller 903, the entire data is not encrypted. Thus, ENC2[0] is always set to be 0.

In the case that data is sent to the data distribution terminal, when encryption is performed on a particular data, the host device sets ENC1[1] to be 1 and thereby notifies that the data is sent in an encrypted form. In contrast, when encryption is not performed, the host device sets ENC1[1] to be 0 and thereby notifies that the data is sent in a non-encrypted form. When data is sent through the non-encrypted wireless communication controller 903, the entire data is not encrypted. Thus, ENC2[1] is always set to be 0.

According to the registers having the above-mentioned configuration, in the data transfer using encryption, in the case that a part of data requires encryption while the other part does not require encryption, the presence or absence of encryption in each part of the data can be notified and set up correctly.

In the confidential information processing system employing the memory-equipped wireless communication card 1100, data storing using the memory unit 1101 can be performed. At that time, the host device need notify to the memory-equipped wireless communication card whether the data is to be stored into the memory unit 1101 or alternatively data transfer similar to that of the wireless communication card 900 shown in FIG. 22 without data storing is to be performed. Thus, in the communication circuit information register 1400 shown in FIG. 27, bits are prepared for notifying whether the memory unit 1101 of the memory-equipped wireless communication card 1100 is to be used in the data transfer.

FIG. 28A shows an example of configuration of the communication circuit information register 1400 shown in FIG. 27. Here, bits denoted by STOR1 and STOR2 in the communication circuit information register 1400 set up the presence or absence of data storing. Here, the wireless communication card 900 shown in FIG. 22 has no memory unit. Thus, STOR1 and STOR2 of the communication circuit information register 1400 are not present in this case.

Each of STOR1 and STOR2 is composed of a single bit and can be read and written from the host device. STOR1 indicates information concerning the wireless communication controller 901 in the memory-equipped wireless communication card 1100, while STOR2 indicates information concerning the non-encrypted wireless communication controller 903. Thus, in the case that n wireless communication controllers are present in the wireless communication card, n bits ranging from STOR1 to STORn are present. Here, each bit of 1 indicates that data is stored in the use of the corresponding wireless communication controller. In contrast, each bit of 0 indicates that data is not stored in the use of the corresponding wireless communication controller. The assignment of 0 and 1 may be reversed.

According to the registers having the above-mentioned configuration, the host device can notify the switching between data transfer using the memory unit and data transfer not using the memory unit.

In the confidential information processing system of the present embodiment, when the host device uses the wireless communication controller of the wireless communication card or the memory-equipped wireless communication card, authentication processing is required between the host device and the card. In this case, after the authentication processing, the host device need recognize whether the authentication processing has been completed correctly. Thus, in the authentication information register 1401 shown in FIG. 27, bits are prepared for notifying to the host device whether the authentication processing has been completed correctly.

FIG. 28B shows an example of configuration of the authentication information register 1401 shown in FIG. 27. This example is a configuration common to the wireless communication card and the memory-equipped wireless communication card. Here, bits denoted by AEND1 and AEND2 in the authentication information register 1401 indicate whether the authentication processing has been completed correctly. Each of AEND1 and AEND2 is composed of a single bit and is read-only from the host device. AEND1 indicates information concerning the wireless communication controller 901, while AEND2 indicates information concerning the non-encrypted wireless communication controller 903. Thus, in the case that n wireless communication controllers are present in the wireless communication card, n bits ranging from AEND1 to AENDn are present. Here, each bit of 1 indicates that the authentication processing has been completed correctly for the corresponding wireless communication controller In contrast, each bit of 0 indicates that the authentication processing has not been completed for the corresponding wireless communication controller. The assignment of 0 and 1 may be reversed.

In the case of the memory-equipped wireless communication card of FIG. 24, authentication processing is necessary for the wireless communication controller 901. Thus, AEND1 is set to be 0 before and during the authentication processing. Then, when the authentication processing has been completed, AEND1 is set to be 1. In contrast, authentication processing is unnecessary for the non-encrypted wireless communication controller 903. Thus, AEND2 is always set to be 1. Each bit of 1 indicates that the authentication processing has been completed correctly. Thus, the host device is allowed to control the wireless communication controller.

According to the registers having the above-mentioned configuration, the host device can be notified whether authentication processing has been completed correctly in the use of the wireless communication controller.

In the confidential information processing system of the present invention, a data confidentiality function is provided between the wireless communication card and the host device in addition to that between the data distribution terminal and the wireless communication card. This improves security in a wireless communication system or the like for transferring encrypted data.

Although the present invention has been fully described by way of examples with reference to the accompanying drawings, it is to be noted that various changes and modifications will be apparent to those skilled in the art, Therefore, unless otherwise such changes and modifications depart from the scope of the present invention, they should be construed as being included therein.

What is claimed is:

1. A communication card connectable to a host device, comprising:
an interface unit operable to communicate with the host device;
a first communication unit operable to communicate with an external device other than the host device;
an encryption unit operable to perform encryption processing onto data transferred between the host device and the external device via said interface unit and said first communication unit;
a storage unit operable to store the following: list information indicating a list of identifiers of unauthorized communication cards; and communication key information used for performing encryption processing onto the data; and
a control unit operable to:
perform authentication processing between said communication card and the host device, and only when the authentication processing has been completed normally,
allow the host device to control said first communication unit, cause said encryption unit to encrypt the data by using the communication key information after the authentication processing, and
transfer the encrypted data to the host device via said interface unit,
wherein the authentication processing includes processing of revoking, by using the list information, an unexpected unauthorized communication card.

2. The communication card according to claim 1, further comprising a memory unit operable to store data,
wherein said control unit is operable to:
cause said encryption unit to encrypt, by using the communication key information, the data received from the external device by said first communication unit,
store the encrypted data into said memory unit, and
transfer the encrypted data stored in said memory unit to the host device through said interface unit;
store in said memory unit the encrypted data received from the host device by said interface unit, and
cause said encryption unit to decrypt by using the communication key information the encrypted data stored in said memory unit; and
transfer the decrypted data to the external device via said first communication unit.

3. The communication card according to claim 1,
wherein said control unit is operable to perform first, second, and third processing in the authentication processing,
the first processing is processing of determining whether both of said communication card and the host device are authorized ones,
the second processing is processing of revoking an unexpected unauthorized host device, and
the third processing is processing of revoking, by using the list information, an unexpected unauthorized communication card.

4. The communication card according to claim 1,
wherein said first communication unit has an encryption circuit operable to perform encryption processing onto the data, and operable to communicate, with said external device, encrypted data encrypted by said encryption circuit,
said communication card further comprises a second communication unit operable to communicate non-encrypted data with the external device, and
said control unit is operable to:
allow the host device to use said second communication unit without authentication processing, and
transfer non-encrypted data between said second communication unit and said interface unit.

5. The communication card according to claim 1,
wherein said first communication unit has a first encryption circuit operable to perform encryption processing onto communication data, and is operable to communicate, with said external device, encrypted data encrypted by said first encryption circuit,
said communication card further comprises one or more second communication units, each of which has a second encryption circuit operable to perform encryption processing onto communication data, and is operable to communicate to an external device encrypted data generated by said second encryption circuit, and
said control unit is further operable to:
perform authentication processing between said communication card and host devices, using individually different information, and,
only when the authentication processing has been completed normally, allow a host device to control said second communication unit corresponding to each authentication processing, then after the authentication processing, cause said encryption unit to encrypt the data by using communication key information different from the communication key information, and transfer the encrypted data to the host device via said interface unit.

6. The communication card according to claim 1,
wherein said first communication unit has a first encryption circuit operable to perform encryption processing onto communication data, and is operable to communicate, with said external device, encrypted data encrypted by said first encryption circuit,
said communication card further comprises one or more second communication units, each of which has a second encryption circuit operable to perform encryption processing onto communication data, and is operable to communicate to an external device encrypted data generated by said second encryption circuit, and
when the authentication processing has been completed normally, said control unit is further operable to:
allow the host device to control each of said second communication units,
cause said encryption unit to encrypt, by using the communication key information, the data obtained from said second communication unit, and
transfer the encrypted data to the host device via said interface unit.

7. The communication card according to claim 1, further comprising
a holding unit operable to hold at least one of (i) authentication information indicating whether authentication processing is necessary between a host device and a communication card, (ii) encryption information indicating whether encryption processing is necessary between a host device and a communication card, (iii) memory information indicating whether data is stored in said memory unit, and (iv) completion information indicating whether authentication processing has been completed normally,
wherein said control unit is operable to control said first communication unit in accordance with the information held in said holding unit.

8. The communication card according to claim 3,
wherein said storage unit has a public area which is an area accessible even from an unauthenticated host device and a hidden area which is an area accessible only from an authorized and authenticated host device,
said public area has a first area that can only be read by a host device,
said first area holds an authentication card key which is a key proper to each communication card and used in the third processing,
said hidden area has a second area which is an area that cannot be read and written by a host device,
said second area holds a first authentication key which is an expected value of a first authentication key generated in the first or the second processing, and
the authentication card key is encrypted with the first authentication key.

9. The communication card according to claim 8,
wherein said second area further holds a communication key which is a key used for encryption and decryption of data by said communication card, the communication key being included in the communication key information.

10. The communication card according to claim 9,
wherein said control unit is operable, in the first processing, to authenticate an authorization status of a host device by using the following: an authentication host key indicating an identifier of the host device; and a first authentication slave key indicating a list of identifiers of authorized host devices,
in the second processing, to revoke an unauthorized host device by using the authentication host key, and a second authentication slave key indicating a list of identifiers of unexpected unauthorized host devices, and
in the third processing, to provide to the host device the authentication card key and a third authentication slave key which is said list information, and to cause said host device to revoke an unauthorized communication card, and
wherein the second processing is omitted in a case that the second authentication slave key is not present, and
the third processing is omitted in a case that the third authentication slave key is not present.

11. The communication card according to claim 10,
wherein said hidden area further has a third area which is an area that can be read and written by the host device only when the authentication processing has been completed normally,
said third area holds the communication key, and
the communication key is
encrypted in advance with the first authentication key in a case that only the first processing is performed in the authentication processing,
encrypted in advance with a second authentication key which is a key generated in the second processing, in a case that only the first processing and the second processing are performed in the authentication processing,
and encrypted in advance with a third authentication key which is a key generated in the third processing, in a case that the first processing through the third processing are performed in the authentication processing or alternatively in a case that only the first processing and the third processing are performed.

12. The communication card according to claim 10,
wherein said public area further has a fourth area which is an area that can be read and written by a host device,
said fourth area is an area operable to hold the third authentication slave key, and
the third authentication slave key is:
encrypted in advance with a first authentication intermediate key which is a key generated in the first processing, in a case that only the first processing and the third processing are performed in the authentication processing; and
encrypted in advance with a second authentication intermediate key which is a key generated in the second processing, in a case that the first processing through the third processing are performed in the authentication processing.

13. A confidential information processing system comprising a host device and a communication card connectable to said host device,
said communication card including:
an interface unit operable to communicate with said host device,
a first communication unit operable to communicate with an external device other than said host device,
an encryption unit operable to perform encryption processing onto data transferred between said host device and the external device via said interface unit and said first communication unit,
a storage unit operable to store the following: list information indicating a list of identifiers of unauthorized communication cards;
and communication key information used for performing encryption processing onto the data, and
a first control unit operable to control said communication card,
said host device including:
a card slot operable to connect with said communication card, and
a second control unit operable to control said host device,
wherein said host device and said communication card perform authentication processing between said communication card and said host device, and
only when the authentication processing has been completed normally, said first control unit is operable to:
allow said host device to control said first communication unit;
cause said encryption unit to encrypt the data by using the communication key information after the authentication processing, and
transfer the encrypted data to said host device via said interface unit, and
wherein the authentication processing includes processing of revoking, by using the list information, an unexpected unauthorized communication card.

14. The confidential information processing system according to claim 13,
wherein said first and said second control units are operable to perform first, second, and third processing in the authentication processing,
the first processing is processing of determining whether both of said communication card and said host device are authorized ones,
the second processing is processing of revoking an unexpected unauthorized host device, and
the third processing is processing of revoking, by using the list information, an unexpected unauthorized communication card.

15. The confidential information processing system according to claim 14,
wherein in the third processing, said first and said second control units are operable to determine whether said communication card is an unauthorized communication card, by using an authentication card key which is a key proper to each communication card, and a third authentication slave key which is said list information.

16. The confidential information processing system according to claim 15,
wherein said first and said second control units are operable, in the first processing, to authenticate an authorization status of a host device by using the following: an authentication host key indicating an identifier of said host device; and a first authentication slave key indicating a list of identifiers of authorized host devices,
in the second processing, to revoke an unauthorized host device by using the authentication host key and a second authentication slave key indicating a list of identifiers of unexpected unauthorized host devices, and
in the third processing, to provide to said host device the authentication card key and a third authentication slave key which is the list information, and to cause said host device to revoke an unauthorized communication card, and
wherein the second processing is omitted in a case that the second authentication slave key is not present, and
said third processing is omitted in a case that the third authentication slave key is not present.

17. The confidential information processing system according to claim 16,
wherein said first and said second control units are operable to:
perform the third processing after the second processing in a case that the second authentication slave key and the third authentication slave key are present, and
perform the third processing after the first processing in a case that the second authentication slave key is not present and the third authentication slave key is present.

18. The confidential information processing system according to claim 16,
wherein said second control unit is operable to decrypt said authentication card key encrypted in advance, with a first authentication key generated in the first processing, in a case that the third authentication slave key is present.

19. The confidential information processing system according to claim 16,
wherein said second control unit, in a case that the first processing and the third processing are performed, is operable to:
decrypt the third authentication slave key encrypted in advance, with a first authentication intermediate key; and
decrypt the key with a second authentication intermediate key in a case that the first processing, the second processing and the third processing are performed.

20. The confidential information processing system according to claim 16,
wherein said second control unit is operable to:
generate a third intermediate key in the third processing, and
generate a third authentication key from the third intermediate key and a card number which is a number proper to each communication card.

21. The confidential information processing system according to claim 16,
wherein when receiving a report of an unexpected unauthorized communication card, said second control unit is further operable to:
update the third authentication slave key, and
issue the updated third authentication slave key to said communication card.

22. The confidential information processing system according to claim 21,
wherein said storage unit has a public area which is an area accessible even from an unauthenticated host device and a hidden area which is an area accessible only from an authorized and authenticated host device,
said public area has a first area that can only be read by a host device,
said first area holds an authentication card key which is a key proper to each communication card and used in the third processing,
said hidden area has a second area which is an area that cannot be read and written by a host device and a third area which is an area that can be read and written by a host device only when said authentication processing has been completed normally,
said second area holds a first authentication key which is an expected value of a first authentication key generated in the first processing, and a communication key which is a key used for encryption and decryption of data by said communication card, the communication key being included in the communication key information,
said third area holds a communication key which is the communication key having been encrypted, and is included in the communication key information,
said public area further has a fourth area which is an area that can be read and written by a host device, and
said fourth area is an area operable to hold the third authentication slave key.

23. The confidential information processing system according to claim 22,
wherein when the third authentication slave key is updated, said second control unit is further operable to re-encrypt the encrypted communication key held in said third area, with an updated third authentication key generated in the third processing using the updated third authentication slave key.

24. The confidential information processing system according to claim 22,
wherein in a case that the communication key is encrypted with the first authentication key and stored in said communication card, after normal completion of authentication processing between said communication card and said host device, said first control unit is operable to:
re-generate a communication key in said communication card,
change, by using the re-generated communication key, the communication key in said second area and the encrypted communication key in said third area, and
perform data encryption processing with the changed communication key.

25. A confidential information transfer method used in a communication card including: an interface unit which communicates with a host device; a first communication unit which communicates with an external device other than the host device; an encryption unit which performs encryption processing onto data transferred between the host device and the external device via the interface unit and the first communication unit; and a memory unit which stores list information indicating a list of unauthorized communication cards and communication key information used for performing encryption processing onto the data, said method comprising:
performing, between the communication card and the host device, authentication processing that includes processing of revoking, by using the list information, an unexpected unauthorized communication card;
allowing the host device to control the first communication unit only when the authentication processing has been completed normally; and
causing the encryption unit to encrypt the data by using the communication key information after the authentication processing, and transferring the encrypted data to the host device via the interface unit.
